(19) United States
(12) Patent Application Publication
(10) Pub. No.: US 2026/0040206 A1
(43) Pub. Date: Feb. 5, 2026

(54) METHOD AND DEVICE FOR ACCESS TO NON-ANCHOR NETWORK ENERGY SAVING (NES) CELL IN NEXT GENERATION MOBILE COMMUNICATION SYSTEM

(71) Applicant: Samsung Electronics Co., Ltd., Suwon-si, Gyeonggi-do (KR)

(72) Inventors: Sangyeob JUNG, Suwon-si (KR); Anil AGIWAL, Suwon-si (KR)

(21) Appl. No.: 19/150,041

(22) PCT Filed: Jan. 23, 2024
(86) PCT No.: PCT/KR2024/001077

§ 371 Date: Jul. 22, 2025

(30) Foreign Application Priority Data
Jan. 25, 2023 (KR) 10-2023-0009465

(51) Int. Cl. H04W 48/20; H04B 17/318; H04W 74/0833; H04W 76/27

(52) U.S. Cl. CPC H04W 48/20; H04B 17/328; H04W 74/0833; H04W 76/27

(57) ABSTRACT

The present disclosure relates to a 5G or 6G communication system for supporting higher data transmission rates. Disclosed are a method and a device for supporting access by a terminal to a NES cell, the method comprising the steps of: receiving, in a radio resource control (RRC) inactive mode or an RRC idle mode, system information from a camp-on first cell; acquiring, from the system information, system information about a second cell that does not perform system information transmission; determining, on the basis of threshold value information about the reception signal strength included in the system information about the second cell, whether a condition for access to the second cell is satisfied; and performing, if the condition is satisfied, a random access procedure for the access to the second cell.

### TECHNICAL FIELD

The disclosure relates to a method and an apparatus for supporting access by a terminal to a NES cell.

### BACKGROUND ART

5G mobile communication technology defines a wide frequency band to enable fast transmission speeds and new services, and can be implemented not only in a sub-6 GHz frequency band such as 3.5 gigahertz (3.5 GHz), but also in an ultra-high frequency band (‘above 6 GHz’) called millimeter wave (mm Wave) such as 28 GHz and 39 GHz. In addition, in the case of 6G mobile communication technology, which is called systems beyond 5G communication, implementation in a terahertz band (e.g., 95 GHz to 3 terahertz (3 THz) band) is being considered to achieve a transmission speed that is 50 times faster than the 5G mobile communication technology and an ultra low latency time that is reduced by 1/10.

In the early stages of the 5G mobile communication technology, with the goal of ensuring service support and performance requirements for enhanced mobile broadband (eMBB), ultra-reliable low-latency communications (URLLC), and massive machine-type communications (mMTC), standardization has been made for beamforming and massive MIMO for mitigating a path loss of radio waves in a ultra-high frequency band and increase a transmission distance of the radio waves, support for various numerologies for efficient utilization of ultra-high frequency resources (operation of multiple subcarrier intervals, etc.) and dynamic operation of slot formats, initial access technology for supporting multi-beam transmission and broadband, definition and operation of a band-wide part (BWP), new channel coding methods, such as a low density parity check (LDPC) code for large-scale data transmission and a polar code for high reliable transmission of control information, L2 pre-processing, network slicing providing a dedicated network specialized for a specific service, etc.

Currently, discussions are underway for improvement and performance enhancement of the initial 5G mobile communication technology in consideration of services that the 5G mobile communication technology is intended to support, and physical layer standardization is in progress for technologies such as vehicle-to-everything (V2X) to help autonomous vehicles determine their driving based on their own locations and status information that the autonomous vehicles transmit and to increase user convenience, new radio unlicensed (NR-U) for system operation that meets various regulatory requirements in an unlicensed band, NR UE low power consumption technology (UE power saving), a non-terrestrial network (NTN) that is UE-satellite direct communication to secure coverage in areas where communication with a terrestrial network is impossible, and positioning.

In addition, standardization of wireless interface architecture/protocol fields is in progress for technologies such as industrial Internet of Things (IIoT) for supporting new services through linkage and convergence with other industries, integrated access and backhaul (IAB) that integrates and supports wireless backhaul links and access links to provide nodes for expanding network service areas, mobility enhancement including conditional handover and dual active protocol stack (DAPS) handover, and 2-step RACH for NR that simplifies random access procedures, and standardization of system architecture/service fields is also in progress for 5G baseline architecture (e.g., service based architecture, and service based interface) for combining network functions virtualization (NFV), software-defined networking (SDN) technology, mobile edge computing (MEC) that receives services based on a location of a UE, etc.

When such 5G mobile communication systems are commercialized, an explosive increase in connected devices will be connected to a communication network, so it is expected that improved functionality and performance of the 5G mobile communication systems and the integrated operation of the connected devices will be required. To this end, new researches are expected to be conducted on extended reality (XR) to efficiently support augmented reality (AR), virtual reality (VR), and mixed reality (MR), etc., improvement in 5G performance and reduction in complexity using artificial intelligence (AI) and machine learning (ML), AI service support, metaverse service support, drone communications, etc.

In addition, the development of these 5G mobile communication systems may serve as a basis for the development of not only multi-antenna transmission technology such as new waveform, full dimensional MIMO (FD-MIMO), array antenna, and large scale antenna to ensure coverage in the terahertz band of 6G mobile communication technology, high-dimensional spatial multiplexing technology using metamaterial-based lenses and antennas and orbital angular momentum (OAM) to improve the coverage of terahertz band signals, and reconfigurable intelligent surface (RIS) technology, but also full duplex technology for enhancing frequency efficiency and improving a system network of 6G mobile communication technology, AI-based communication technology that utilizes satellite and AI from the design stage and incorporates end-to-end AI support functions to realize system optimization, and next generation distributed computing technology that realizes services with complexity that exceeds the limits of UE computing capabilities by utilizing ultra-high-performance communication and computing resources, etc.

Meanwhile, an SIB-less NES cell, which does not transmit SIB, may be defined for the purpose of saving power consumption of network equipment. Such an SIB-less NES cell may not transmit not only SIB but also paging messages. Therefore, there is a need to define a method for a terminal to access an SIB-less NES cell, which does not transmit SIB and paging messages, for connection to a cell or connection re-establishment.

### DISCLOSURE OF INVENTION

### Technical Problem

The present disclosure is directed to provide a method and device for a terminal to access a NES cell.

In addition, the present disclosure is directed to provide a method and an apparatus for providing a terminal with information necessary for a terminal to access a NES cell.

### Solution to Problem

According to an aspect of the present disclosure, a method of a terminal in a wireless communication system includes: receiving system information from a camped-on first cell in a radio resource control (RRC) inactive mode or an RRC idle mode; acquiring, from the system information, system information for a second cell that does not perform system information transmission; determining, based on threshold information about received signal strength included in the system information for the second cell, whether a condition for access to the second cell is fulfilled; and performing a random access procedure for access to the second cell when the condition is fulfilled.

According to another aspect of the present disclosure, a method of a base station in a wireless communication system includes: transmitting, to a terminal, an RRC release message which instructs a state of a terminal to transition to a radio resource control (RRC) inactive mode or an RRC idle mode; and transmitting system information to the terminal camped-on a first cell of the base station, in which the system information includes system information for a second cell that does not perform the system information transmission, and the system information for the second cell includes threshold information about received signal strength used to determine a condition for the terminal to access the second cell.

According to still another aspect of the present disclosure, a terminal in a wireless communication system includes: a transceiver; and a controller controlling the transceiver to receive system information from a camped-on first cell in a radio resource control (RRC) inactive mode or an RRC idle mode, acquiring, from the system information, system information for a second cell that does not perform system information transmission, determining, based on threshold information about received signal strength included in the system information for the second cell, whether a condition for access to the second cell is fulfilled, and performing a random access procedure for access to the second cell when the condition is fulfilled.

According to still yet another aspect of the present disclosure, a base station in a wireless communication system includes: a transceiver; and a controller controlling the transceiver to transmit, to a terminal, an RRC release message which instructs a state of a terminal to transition to a radio resource control (RRC) inactive mode or an RRC idle mode, and transmit system information to the terminal camped on a first cell of the base station, in which the system information includes system information for a second cell that does not perform the system information transmission, and the system information for the second cell includes threshold information about received signal strength used to determine a condition for the terminal to access the second cell.

### Advantageous Effects of Invention

According to an example of the present disclosure, by allowing an anchor cell located around an SIB-less NES cell to appropriately provide information necessary for access to the SIB-less NES cell, connection re-establishment of the SIB-less NES cell, etc., through various signaling and parameters, it is possible to support access by a terminal.

### BRIEF DESCRIPTION OF DRAWINGS

FIG. 1 illustrates a structure of an LTE system according to an embodiment of the present disclosure.

FIG. 2 illustrates a wireless protocol structure in the LTE system according to an embodiment of the present disclosure.

FIG. 3 illustrates a structure of a next generation mobile communication system according to an embodiment of the present disclosure.

FIG. 4 illustrates a wireless protocol structure of the next generation mobile communication system according to an embodiment of the present disclosure.

FIG. 5 illustrates a cell reselection procedure by a terminal in the next generation mobile communication system according to one embodiment of the present disclosure.

FIG. 6 illustrates a concept of SIB-less network energy saving (NES) according to one embodiment of the present disclosure.

FIG. 7 illustrates an operation of receiving SIB and paging of an SIB-less NES cell through an anchor cell according to an embodiment of the present disclosure.

FIG. 8 illustrates a method for an NES UE to access an SIB-less NES cell according to an embodiment of the present disclosure.

FIG. 9 illustrates a base station to redirect an NES UE to an anchor cell according to an embodiment of the present disclosure.

FIG. 10 illustrates a block diagram of an internal structure of a terminal according to an embodiment of the present disclosure.

FIG. 11 illustrates a block diagram of a configuration of an NR base station according to an embodiment of the present disclosure.

### MODE FOR THE INVENTION

Hereinafter, operation principles of the present disclosure will be described in detail with reference to the accompanying drawings. When it is determined that the detailed description of the known functions or configurations in describing the present disclosure below may obscure the gist of the present disclosure, the detailed description thereof will be omitted. Further, the following terminologies are defined in consideration of the functions in the present disclosure and may be construed in different ways by the intention of users and operators, practice, etc. Therefore, the definitions thereof should be construed based on the contents throughout the specification.

When it is determined that the detailed description of the known functions or configurations in describing the present disclosure below may obscure the gist of the present disclosure, the detailed description thereof will be omitted. Hereinafter, embodiments of the present disclosure will be described with reference to the accompanying drawings.

In the following description, terms for identifying connection nodes, terms referring to network entities, terms referring to messages, terms referring to interfaces between network entities, terms referring to various types of identification information, etc., are provided for the convenience of description. Accordingly, the present disclosure is not limited to terms described below, and other terms referring to objects having equivalent technical meanings may be used.

Hereinafter, for convenience of description, the present disclosure uses terms and names defined in the 3rd generation partnership project long term evolution (3GPP LTE) standards. However, the present disclosure is not limited to the above terms and names, and may be equally applied to systems that follow other standards. In the present disclosure, eNB may be used interchangeably with gNB for convenience of description. That is, a base station described as eNB may represent gNB.

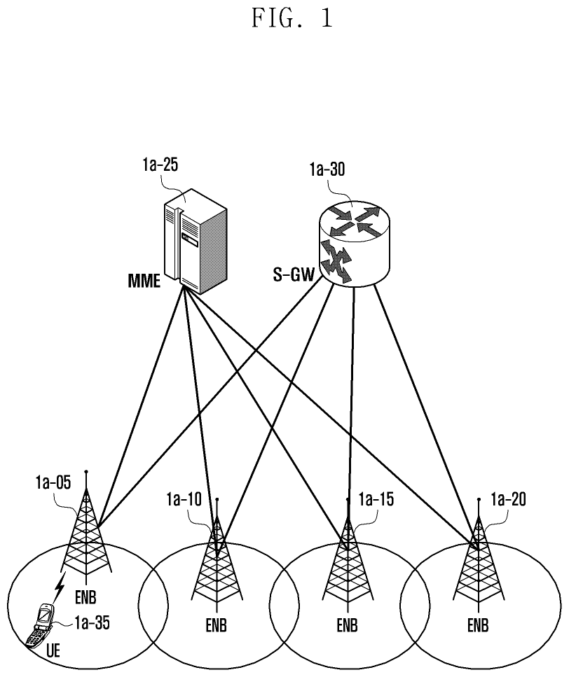

FIG. 1 illustrates a structure of an LTE system according to an embodiment of the present disclosure.

Referring to FIG. 1, as illustrated, a wireless access network of an LTE system may be composed of next generation base stations (Evolved Node B, hereinafter referred to as ENB, Node B, or base station) 1a-05, 1a-10, 1a-15, and 1a-20, a mobility management entity (MME) 1a-25, and a serving-gateway (S-GW) 1a-30. User equipment (hereinafter referred to as UE or terminal) 1a-35 accesses an external network through the ENBs 1a-05 to 1a-20 and the S-GW 1a-30.

In FIG. 1, the ENBs 1a-05 to 1a-20 correspond to the legacy node B of a UMTS system. The ENB is connected to the UE 1a-35 through a wireless channel and performs a more complex role than the legacy node B. In the LTE system, since all user traffic including real-time services such as voice over IP (VOIP) via the Internet protocol is served through a shared channel, a device that collects status information, such as a buffer status, an available transmission power status, and a channel status of the UEs, and performs scheduling is required, which may be handled by the ENBs 1a-05 to 1a-20. One ENB usually controls multiple cells. For example, in order to implement a transmission rate of 100 Mbps, the LTE system uses, for example, orthogonal frequency division multiplexing (hereinafter, referred to as OFDM) as a wireless access technology in a 20 MHz bandwidth. In addition, an adaptive modulation & coding (hereinafter, referred to as AMC) scheme that determines a modulation scheme and a channel coding rate according to the channel status of the UE is applied.

The S-GW 1a-30 is an entity that provides a data bearer and creates or removes the data bearer under the control of the MME 1a-25.

The MME is an entity that is responsible for various control functions as well as a mobility management function for UE and is connected to a plurality of base stations.

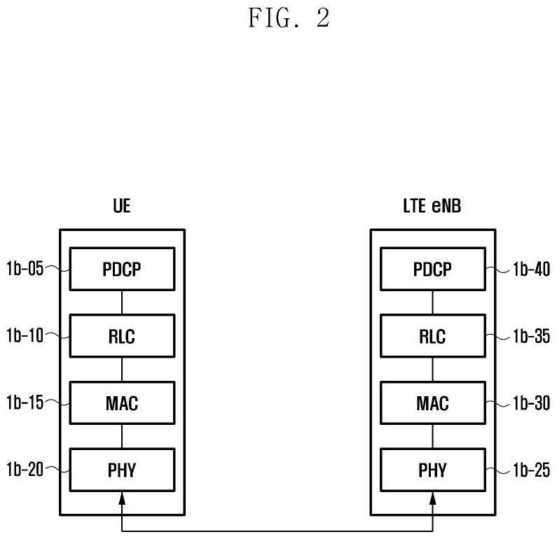

FIG. 2 illustrates a wireless protocol structure in the LTE system according to an embodiment of the present disclosure.

Referring to FIG. 2, the wireless protocol of the LTE system is composed of packet data convergence protocol (PDCP) 1b-05 and 1b-40, radio link controls (RLCs) 1b-10 and 1b-35, and medium access controls (MACs) 1b-15 and 1b-30 in the UE and the ENB, respectively.

The PDCPs 1b-05 and 1b-40 are responsible for operations such as IP header compression/reconstruction. The main functions of the PDCP are summarized as follows.
Header compression and decompression function (Header compression and decompression: ROHC only)
User data transfer function (Transfer of user data)
In-sequence delivery function (In-sequence delivery of upper layer PDUs at PDCP re-establishment procedure for the RLC AM)
Reordering function (For split bearers in DC (only support for the RLC AM): the PDCP PDU routing for transmission and the PDCP PDU reordering for reception)
Duplicate detection function (Duplicate detection of lower layer SDUs at PDCP re-establishment procedure for the RLC AM)
Retransmission function (Retransmission of PDCP SDUs at handover and, for split bearers in DC, of PDCP PDUs at the PDCP data-recovery procedure, for the RLC AM)
Ciphering and deciphering function (Ciphering and deciphering)
Timer-based SDU discard function (Timer-based SDU discard in uplink)

The RLCs 1b-10 and 1b-35 reconstructs a protocol data unit (PDCP PDU) to an appropriate size and performs an ARQ operation, etc. The main functions of the RLC are summarized as follows.
Data transfer function (Transfer of upper layer PDUs)
ARQ function (Error Correction through ARQ (only for AM data transfer))
Concatenation, segmentation, and reassembly function (Concatenation, segmentation and reassembly of the RLC SDUs (only for UM and AM data transfer))
Re-segmentation function (Re-segmentation of RLC data PDUs (only for AM data transfer))
Reordering function (Reordering of the RLC data PDUs (only for UM and AM data transfer))
Duplicate detection function (Duplicate detection (only for UM and AM data transfer))
Error detection function (Protocol error detection (only for AM data transfer))
RLC SDU discard function (RLC SDU discard (only for UM and AM data transfer))
RLC re-establishment function (RLC re-establishment)

The MACs 1b-15 and 1b-30 are connected to a plurality of RLC layer entities configured in one UE and may perform operations of multiplexing RLC PDUs into a MAC PDU and demultiplexing the RLC PDUs from the MAC PDU. The main functions of the MAC are summarized as follows.
Mapping function (Mapping between logical channels and transport channels)
Multiplexing and demultiplexing function (Multiplexing/demultiplexing of MAC SDUs belonging to one or different logical channels into/from transport blocks (TB) delivered to/from the physical layer on transport channels)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

Physical layers 1b-20 and 1b-25 may perform an operation of channel coding and modulating higher layer data, converting the higher layer data into OFDM symbols and transferring the OFDM symbols through a wireless channel, or demodulating and channel decoding the OFDM symbols received through the wireless channel and delivering the OFDM symbols to the higher layer.

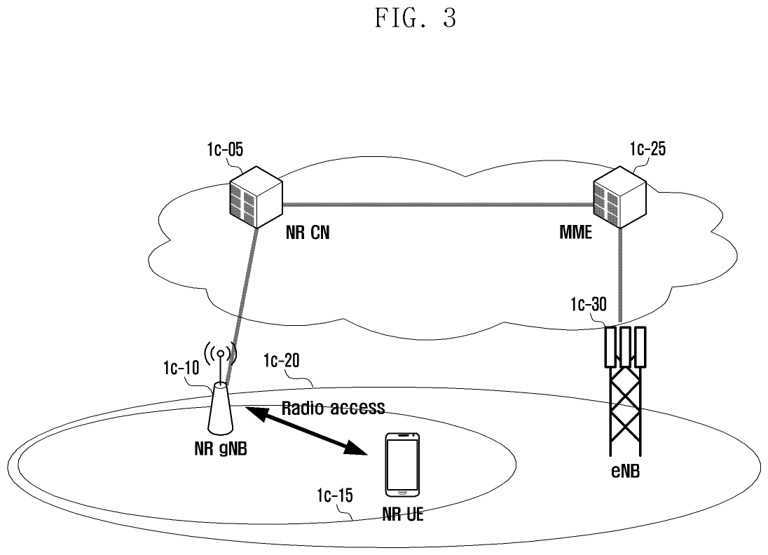

FIG. 3 illustrates a structure of a next generation mobile communication system according to an embodiment of the present disclosure.

Referring to FIG. 3, as illustrated, a wireless access network of a next generation mobile communication system (hereinafter referred to as NR or 2g) is composed of a next generation base station (new radio node B, hereinafter referred to as NR gNB or NR base station) 1c-10 and a new radio core network (NR CN) 1c-05. A user terminal (new radio user equipment, hereinafter referred to as NR UE or UE) 1c-15 accesses an external network through the NR gNB 1c-10 and the NR CN 1c-05.

In FIG. 3, the NR gNB 1c-10 corresponds to an evolved node B (eNB) of the existing LTE system. The NR gNB is connected to the NR UE 1-15 through the wireless channel and may provide a service that is superior to the legacy node B. In the next generation mobile communication system, since all user traffic is served through the shared channel, a device that collects status information such as a buffer status, an available transmission power status, and a channel status of UEs and performs scheduling is required, which may be handled by the NR NB 1c-10. One NR gNB usually controls multiple cells. In order to implement ultra-high-speed data transfer compared to the current LTE, the NR gNB may have a bandwidth greater than or equal to the existing maximum bandwidth, and incorporate beamforming technology in addition to using orthogonal frequency division multiplexing (OFDM) as the wireless access technology. In addition, an adaptive modulation & coding (hereinafter, referred to as AMC) scheme that determines a modulation scheme and a channel coding rate according to the channel status of the UE is applied.

The NR CN 1c-05 performs functions such as mobility support, bearer configuration, and QoS configuration. The NR CN is connected to a plurality of base stations that are responsible for various control functions as well as mobility management functions for the UE. In addition, the next generation mobile communication system may be linked to the existing LTE system, and the NR CN may be connected to an MME 1c-25 via a network interface. The MME is connected to an eNB 1c-30 that is the existing base station.

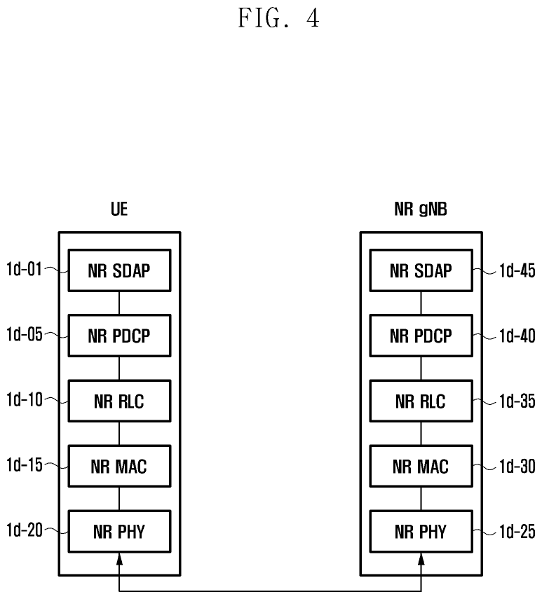

FIG. 4 illustrates a wireless protocol structure of the next generation mobile communication system according to an embodiment of the present disclosure.

Referring to FIG. 4, the wireless protocol of the next generation mobile communication system is composed of an NR service data adaptation protocol (NR SDAPs) 1d-01 and 1d-45, NR PDCPs 1d-05 and 1d-40, NR RLCs 1d-10 and 1d-35, and NR MACs 1d-15 and 1d-30 in the UE and the NR base station, respectively.

The main functions of the NR SDAPs 1d-01 and 1d-45 may include some of the following functions.
User data transfer function (Transfer of user plane data)
Mapping function between QoS flow and data bearers for both uplink and downlink (mapping between a QoS flow and a DRB for both DL and UL)
Marking function QoS flow ID in both uplink and downlink (marking QoS flow ID in both DL and UL packets)
Function of mapping reflective QoS flow to data bearers for uplink SDAP PDUs (reflective QoS flow to DRB mapping for the UL SDAP PDUs)

For the SDAP layer entity, the UE may be configured with whether to use a header of the SDAP layer entity or whether to use a function of the SDAP layer entity for each PDCP layer entity, each bearer, or each logical channel by a radio resource control (RRC) message, and when the SDAP header is configured, the UE may instruct a non-access stratum (NAS) quality of service (QOS) reflection configuration 1-bit indicator (NAS reflective QoS) and an access stratum (AS) QoS reflection configuration 1-bit indicator (AS reflective QoS) of the SDAP header to update or reconfigure the mapping information for the QoS flow and data bearer of the uplink and downlink. The SDAP header may include QoS flow ID information indicating the QoS. The QoS information may be used as data processing priority, the scheduling information, etc., to support seamless services.

The main functions of the NR PDCPs 1d-05 and 1d-40 may include some of the following functions.

Header compression and decompression function (Header compression and decompression: ROHC only)
User data transfer function (Transfer of user data)
In-sequence delivery function (In-sequence delivery of upper layer PDUs)
Out-of-sequence delivery function (Out-of-sequence delivery of upper layer PDUs)
Reordering function (PDCP PDU reordering for reception)
Duplicate detection function (Duplicate detection of lower layer SDUs)
Retransmission function (Retransmission of PDCP SDUs)
Ciphering and deciphering function (Ciphering and deciphering)
Timer-based SDU discard function (Timer-based SDU discard in uplink)

The reordering function of the NR PDCP entity refers to a function of reordering PDCP PDUs received from a lower layer in order based on a PDCP sequence number (PDCP SN). The reordering function may include a function of delivering data to a higher layer in the reordered order, include a function of delivering data directly without considering the order, include a function of recording lost PDCP PDUs by reordering the order, include a function of reporting a status of lost PDCP PDUs to a transmitting side, or include a function of requesting retransmission of the lost PDCP PDUs.

The main functions of the NR RLCs 1d-10 and 1d-35 may include some of the following functions.
Data transfer function (Transfer of upper layer PDUs)
In-sequence delivery function (In-sequence delivery of upper layer PDUs)
Out-of-sequence delivery function (Out-of-sequence delivery of upper layer PDUs)
ARQ function (Error correction through ARQ)
Concatenation, segmentation, and reassembly function (Concatenation, segmentation and reassembly of RLC SDUs)
Re-segmentation function (Re-segmentation of RLC data PDUs)
Reordering function (Reordering of RLC data PDUs)
Duplicate detection function (Duplicate detection)
Error detection function (Protocol error detection)
RLC SDU discard function (RLC SDU discard)
RLC re-establishment function (RLC re-establishment)

The in-sequence delivery function of the NR RLC entity refers to the function of delivering the RLC SDUs received from the lower layer to the higher layer in order. The in-sequence delivery function may include a function of reassembling and delivering the segmented RLC SDUs when one RLC SDU is originally segmented into multiple RLC SDUs and received, include a function of reordering received RLC PDUs based on the RLC sequence number (RLC SN) or PDCP sequence number (PDCP SN), include a function of recording lost RLC PDUs by reordering the order, include a function of reporting a status of the lost RLC PDUs to a transmitting side, include a function of requesting retransmission of the lost RLC PDUs, include a function of delivering only RLC SDUs before the lost RLC SDU to the higher layer in order when there is the lost RLC SDU, include a function of delivering all RLC SDUs received before the timer is initiated to the higher layer in order if a given timer has expired even if there are the lost RLC SDUs, or include a function to deliver all the RLC SDUs received so far to the higher layer in order if a given timer has expired even if there are the lost RLC SDUs. In addition, the RLC PDUs may be processed in the order that the RLC PDUs are received (in the order of arrival regardless of the order of the sequence number) and delivered to a PDCP entity regardless of the order (out-of sequence delivery), or in case of the segments, reconstructed into a single complete RLC PDU from the segments stored in the buffer or to be received later, processed, and delivered to the PDCP entity. The NR RLC layer may not include the concatenation function, and perform the function in the NR MAC layer or be replaced by the multiplexing function of the NR MAC layer.

The out-of-sequence delivery function of the NR RLC entity described above refers to a function of directly delivering the RLC SDUs received from the lower layer to the higher layer regardless of the order. When the original single RLC SDU is segmented into the plurality of RLC SDUs and received, the out-of-sequence delivery function of the NR RLC entity may include a function of reassembling and delivering these RLC SDUs, and include a function of storing and ordering the RLC SN or the PDCP SN of the received RLC PDUs to record the lost RLC PDUs.

The NR MACs 1d-15 and 1d-30 may be connected to a plurality of NR RLC layer entities constructed in one UE, and the main functions of the NR MAC may include some of the following functions.
Mapping function (Mapping between logical channels and transport channels)
Multiplexing/demultiplexing function (Multiplexing/demultiplexing of MAC SDUs)
Scheduling information reporting function (Scheduling information reporting)
HARQ function (Error correction through HARQ)
Priority handling function between logical channels (Priority handling between logical channels of one UE)
Priority handling function between UEs (Priority handling between UEs by means of dynamic scheduling)
MBMS service identification function (MBMS service identification)
Transport format selection function (Transport format selection)
Padding function (Padding)

The NR PHY layers 1d-20 and 1d-25 may perform the operation of channel coding and modulating the higher layer data, converting the higher layer data into the OFDM symbols and transferring the OFDM symbols through the wireless channel, or demodulating and channel decoding the OFDM symbols received through the wireless channel, and delivering the OFDM symbols to the higher layer.

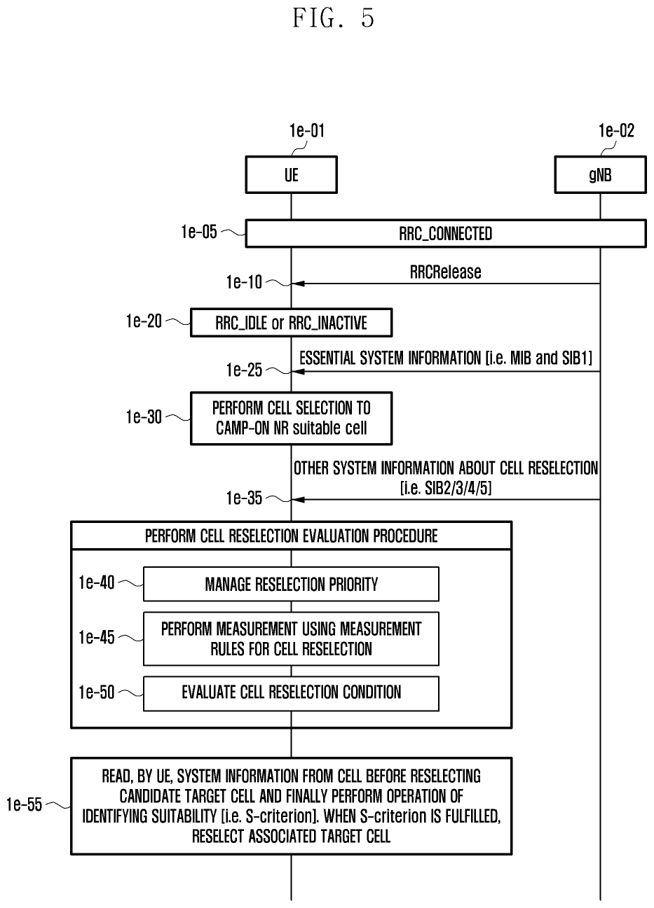

FIG. 5 illustrates a cell reselection procedure by a terminal in the next generation mobile communication system according to one embodiment of the present disclosure.

Referring to FIG. 5, a UE 1e-01 may establish an RRC connection with a gNB 1e-02 and thus may be in an RRC connected mode (RRC_CONNECTED) (1e-05).

In step 1e-10, the gNB 1e-02 may transmit an RRC connection release message (RRCRelease) to the UE 1e-01.

In step 1e-20, the UE 1e-01, which has received the RRCRelease, may transition to the RRC idle mode or the RRC inactive mode. More specifically, when receiving the RRCRelease including suspend configuration information (suspendConfig) in step 1e-10, the UE 1e-01 transitions to the RRC inactive mode (RRC_INACTIVE). If not (e.g., when receiving the RRCRelease that does not include the suspend configuration information), the UE 1e-01 may transition to an RRC idle mode (RRC_IDLE).

In step 1e-25, the UE 1e-01 in the RRC idle mode or the RRC inactive mode may acquire essential system information. The essential system information may mean a master information block (MIB) and a system information block 1 (SIB1).

In step 1e-30, the UE 1e-01 in the RRC idle mode or the RRC inactive mode may perform a cell selection procedure to camp-on an NR suitable cell. A cell camped-on by the UE may be referred to as a serving cell.

In the present disclosure, based on the 3GPP standard document “38.304: User Equipment (UE) procedures in Idle mode and RRC Inactive state,” the cell may be defined as a suitable cell in the present disclosure when the conditions in Table 1 below are fulfilled.

TABLE 1
suitable cell:
For UE not operating in SNPN Access Mode, a cell is considered as
suitable if the following conditions are fulfilled:
-The cell is part of either the selected PLMN or the registered PLMN or
PLMN of the Equivalent PLMN list, and for that PLMN either:
-The PLMN-ID of that PLMN is broadcast by the cell with no associated
CAG-IDs and CAG-only indication in the UE for that PLMN (TS 23.501
[10]) is absent or false;
-Allowed CAG list in the UE for that PLMN (TS 23.501 [10]) includes a
CAG-ID broadcast by the cell for that PLMN;
-The cell selection criteria are fulfilled, see clause 5.2.3.2.
According to the latest information provided by NAS:
-The cell is not barred, see clause 5.3.1;
-The cell is part of at least one TA that is not part of the list of “Forbidden
Tracking Areas for Roaming” (TS 22.011 [18]), which belongs to a
PLMN that fulfils the first bullet above.
For UE operating in SNPN Access Mode, a cell is considered as suitable if
the following conditions are fulfilled:
-The cell is part of either the selected SNPN or the registered SNPN of the
UE;
-The cell selection criteria are fulfilled, see clause 5.2.3.2;
According to the latest information provided by NAS:
-The cell is not barred, see clause 5.3.1;
-The cell is part of at least one TA that is not part of the list of “Forbidden
Tracking Areas for Roaming” which belongs to either the selected SNPN
or the registered SNPN of the UE.

For reference, the UE 1e-01 may determine that the cell selection criteria are fulfilled when the following Mathematical Expression 1 is fulfilled.

$$Srxlev > 0 AND Squal > 0 \qquad Mathematical Expression 1$$

$$where$$

$$Srxlev = {Q}_{rxlevmeas} - ( {Q}_{rxlevmin} + {Q}_{rxlevminoffset} ) - {P}_{compensation} -- {Qoffset}_{temp} ,$$

$$Squal = {Q}_{qualmeas} - ( {Q}_{qualmin} + {Q}_{qualminoffset} ) - {Qoffset}_{temp} .$$

The definition of parameters used herein refers to the 3GPP standard document “38.304: User Equipment (UE) procedures in Idle mode and RRC Inactive state.”

In step 1e-35, the UE 1e-01 in the RRC idle mode or the RRC inactive mode may acquire system information (e.g., SIB2, SIB3, SIB4, SIB5) containing cell reselection information from the gNB 1e-02 to perform a cell reselection evaluation procedure. The SIB2 may include information/parameters commonly applied to the UE when reselecting NR intra-frequency, NR inter-frequency, and inter-RAT frequency cells, and NR intra-frequency cell reselection information excluding information related to NR intra-frequency neighboring cells. For example, the SIB2 may include one cell reselection priority configuration information for a serving NR frequency (frequency to which a currently camped-on cell belongs). The cell reselection priority configuration information may mean cellReselectionPriority and cellReselectionSubPriority. Specifically, cellReselectionPriority may store an integer value (e.g., one integer value from 0 to 7), and cellReselectionSubPriority may store a decimal value (e.g., one decimal value from 0.2, 0.4, 0.6, and 0.8). When both cellReselectionPriority and cellReselectionSubPriority are signaled, the UE may derive a cell reselection priority value by adding the two values. For reference, a larger cell reselection priority value means a higher priority. Specifically, the cell reselection configuration information broadcast through the SIB2 may be as shown in Table 2 below.

TABLE 2

| | |
|---|---|
| SIB2 ::= | SEQUENCE { |
| cellReselectionInfoCommon | SEQUENCE { |

| | |
|---|---|
| nrofSS-BlocksToAverage | INTEGER (2..maxNrofSS- |

| | |
|---|---|
| BlocksToAverage) | OPTIONAL, -- Need S |

| | |
|---|---|
| absThreshSS-BlocksConsolidation | ThresholdNR |

OPTIONAL, -- Need S

| | | |
|---|---|---|
| rangeToBestCell | RangeToBestCell | OPTIONAL, |

-- Need R

| | |
|---|---|
| q-Hyst | ENUMERATED { |

dB0, dB1, dB2, dB3, dB4, dB5, dB6, dB8, dB10,
dB12, dB14, dB16, dB18, dB20, dB22, dB24},

| | |
|---|---|
| speedStateReselectionPars | SEQUENCE { |
| mobilityStateParameters | MobilityStateParameters, |
| q-HystSF | SEQUENCE { |
| sf-Medium | ENUMERATED {dB-6, dB-4, dB-2, dB0}, |
| sf-High | ENUMERATED {dB-6, dB-4, dB-2, dB0} |

}

| | |
|---|---|
| } | OPTIONAL, -- Need |

R
...
},

| cellReselectionServingFreqInfo | SEQUENCE { | |
|---|---|---|
| s-NonIntraSearchP | ReselectionThreshold | OPTIONAL, |

-- Need S

| | | |
|---|---|---|
| s-NonIntraSearchQ | ReselectionThresholdQ | OPTIONAL, |

-- Need S

| | |
|---|---|
| threshServingLowP | ReselectionThreshold, |

| | |
|---|---|
| threshServingLowQ | ReselectionThresholdQ |

OPTIONAL, -- Need R

| cellReselectionPriority | CellReselectionPriority, | |
|---|---|---|
| cellReselectionSubPriority | | CellReselectionSubPriority |

OPTIONAL, -- Need R
...
},

| intraFreqCellReselectionInfo | SEQUENCE { | |
|---|---|---|
| q-RxLevMin | Q-RxLevMin, | |
| q-RxLevMinSUL | Q-RxLevMin | OPTIONAL, |

-- Need R

| | | |
|---|---|---|
| q-QualMin | Q-QualMin | OPTIONAL, |

-- Need S

| s-IntraSearchP | ReselectionThreshold, | |
|---|---|---|
| s-IntraSearchQ | ReselectionThresholdQ | OPTIONAL, |

-- Need S

| | |
|---|---|
| t-ReselectionNR | T-Reselection, |

| | |
|---|---|
| frequencyBandList | MultiFrequencyBandListNR-SIB |

OPTIONAL, -- Need S

| | |
|---|---|
| frequencyBandListSUL | MultiFrequencyBandListNR-SIB |

OPTIONAL, -- Need R

| | | |
|---|---|---|
| p-Max | P-Max | OPTIONAL, - |

- Need S

| | | |
|---|---|---|
| smtc | SSB-MTC | OPTIONAL, - |

- Need S

| | |
|---|---|
| ss-RSSI-Measurement | SS-RSSI-Measurement |

OPTIONAL, -- Need R

| | | |
|---|---|---|
| ssb-ToMeasure | SSB-ToMeasure | OPTIONAL, |

-- Need S

| | |
|---|---|
| deriveSSB-IndexFromCell | BOOLEAN, |

...,
[[

| | | |
|---|---|---|
| t-ReselectionNR-SF | SpeedStateScaleFactors | OPTIONAL |

-- Need N
]],
[[

| | | |
|---|---|---|
| smtc2-LP-r16 | SSB-MTC2-LP-r16 | OPTIONAL, |

-- Need R

| | |
|---|---|
| ssb-PositionQCL-Common-r16 | SSB-PositionQCL-Relation-r16 |

OPTIONAL -- Cond SharedSpectrum
]]
},
...,
[[

| | |
|---|---|
| relaxedMeasurement-r16 | SEQUENCE { |
| lowMobilityEvaluation-r16 | SEQUENCE { |
| s-SearchDeltaP-r16 | ENUMERATED { |

dB3, dB6, dB9, dB12, dB15,
spare3, spare2, spare1},

| | |
|---|---|
| t-SearchDeltaP-r16 | ENUMERATED { |

s5, s10, s20, s30, s60, s120, s180,
s240, s300, spare7, spare6, spare5,
spare4, spare3, spare2, spare 1}

| | |
|---|---|
| } | OPTIONAL, -- Need |

R

| | |
|---|---|
| cellEdgeEvaluation-r16 | SEQUENCE { |
| s-SearchThresholdP-r16 | ReselectionThreshold, |

| | |
|---|---|
| s-SearchThresholdQ-r16 | ReselectionThresholdQ |

OPTIONAL -- Need R

| | |
|---|---|
| } | OPTIONAL, -- Need |

R

| | |
|---|---|
| combineRelaxedMeasCondition-r16 | ENUMERATED {true} |

OPTIONAL, -- Need R

| | |
|---|---|
| highPriorityMeasRelax-r16 | ENUMERATED {true} |

OPTIONAL -- Need R

| | |
|---|---|
| } | OPTIONAL -- |

Need R
]]
}
RangeToBestCell ::= Q-OffsetRange

The SIB3 may include neighboring cell information/parameters for the UE to reselect the NR intra-frequency cell. For example, the SIB3 may include and broadcast an NR intra-frequency cell list (intraFreqNeighCellList) for reselecting the NR intra-frequency cell or a cell list (intraFreqBlackCellList) for which the NR intra-frequency cell reselection is not allowed. Specifically, the SIB3 may include information of Table 3 below.

TABLE 3

| | |
|---|---|
| SIB3 ::= | SEQUENCE { |

| | |
|---|---|
| intraFreqNeighCellList | IntraFreqNeighCellList |

OPTIONAL, -- Need R

| | |
|---|---|
| intraFreqBlackCellList | IntraFreqBlackCellList |

OPTIONAL, -- Need R

| | |
|---|---|
| lateNonCriticalExtension | OCTET STRING |

OPTIONAL,
...,
[[

| | |
|---|---|
| intraFreqNeighCellList-v1610 | IntraFreqNeighCellList-v1610 |

OPTIONAL, -- Need R

| | |
|---|---|
| intraFreqWhiteCellList-r16 | IntraFreqWhiteCellList-r16 |

OPTIONAL, -- Cond SharedSpectrum2

| | |
|---|---|
| intraFreqCAG-CellList-r16 | SEQUENCE (SIZE (1..maxPLMN)) OF |
| IntraFreqCAG-CellListPerPLMN-r16 | OPTIONAL -- Need R |

]]
}

| | |
|---|---|
| IntraFreqNeighCellList ::= | SEQUENCE (SIZE (1..maxCellIntra)) OF |

IntraFreqNeighCellInfo

| | |
|---|---|
| IntraFreqNeighCellList-v1610::= | SEQUENCE (SIZE (1..maxCellIntra)) OF |

IntraFreqNeighCellInfo-v1610

| IntraFreqNeighCellInfo ::= | SEQUENCE { | |
|---|---|---|
| physCellId | PhysCellId, | |
| q-OffsetCell | Q-OffsetRange, | |
| q-RxLevMinOffsetCell | INTEGER (1..8) | OPTIONAL, |

-- Need R

| | |
|---|---|
| q-RxLevMinOffsetCellSUL | INTEGER (1..8) |

OPTIONAL, -- Need R

| | | |
|---|---|---|
| q-QualMinOffsetCell | INTEGER (1..8) | OPTIONAL, |

-- Need R
...
}

| | |
|---|---|
| IntraFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| IntraFreqBlackCellList ::= | SEQUENCE (SIZE (1..maxCellBlack)) OF |

PCI-Range

| | |
|---|---|
| IntraFreqWhiteCellList-r16 ::= | SEQUENCE (SIZE (1..maxCellWhite)) OF |

PCI-Range
IntraFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell-r16)) OF |

PCI-Range
}

The SIB4 may include the information/parameters for the UE to reselect the NR intra-frequency cell. For example, one or more NR inter-frequencies may be broadcast through the SIB4, and one cell reselection priority configuration information may be broadcast for each NR inter-frequency. The cell reselection priority configuration information for each NR inter-frequency means the contents described above, for example, cellReselectionPriority and/or cellReselectionSubPriority mapped to each NR inter-frequency, but has the characteristic that one cell reselection priority configuration information for each inter-frequency is optionally included in the SIB4. Specifically, the SIB4 may include information of Table 4 below.

TABLE 4

| SIB4 ::= | SEQUENCE { | |
|---|---|---|
| interFreqCarrierFreqList | InterFreqCarrierFreqList, | |
| lateNonCriticalExtension | OCTET STRING | OPTIONAL, |

...,
[[

| | |
|---|---|
| interFreqCarrierFreqList-v1610 | InterFreqCarrierFreqList-v1610 |

OPTIONAL -- Need R
]]
}

| | |
|---|---|
| InterFreqCarrierFreqList ::= | SEQUENCE (SIZE (1..maxFreq)) OF |

InterFreqCarrierFreqInfo

| | |
|---|---|
| InterFreqCarrierFreqList-v1610 ::= | SEQUENCE (SIZE (1..maxFreq)) OF |

InterFreqCarrierFreqInfo-v1610

| | |
|---|---|
| InterFreqCarrierFreqInfo ::= | SEQUENCE { |
| dl-CarrierFreq | ARFCN-ValueNR, |

| | |
|---|---|
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| | |
|---|---|
| nrofSS-BlocksToAverage | INTEGER (2..maxNrofSS- |

| | |
|---|---|
| BlocksToAverage) | OPTIONAL, -- Need S |

| | |
|---|---|
| absThreshSS-BlocksConsolidation | ThresholdNR |

OPTIONAL, -- Need S

| | | |
|---|---|---|
| smtc | SSB-MTC | OPTIONAL, |

-- Need S

| | |
|---|---|
| ssbSubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL,

| | |
|---|---|
| q-RxLevMin | Q-RxLevMin, |

| | |
|---|---|
| q-RxLevMinSUL | Q-RxLevMin |

OPTIONAL, -- Need R

| | | |
|---|---|---|
| q-QualMin | Q-QualMin | OPTIONAL, |

-- Need S

| | | |
|---|---|---|
| p-Max | P-Max | OPTIONAL, |

-- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |
| threshX-LowQ | ReselectionThresholdQ |

| | |
|---|---|
| } | OPTIONAL, -- |

Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | | |
|---|---|---|
| q-OffsetFreq | Q-OffsetRange | DEFAULT |

dB0,

| | |
|---|---|
| interFreqNeighCellList | InterFreqNeighCellList |

OPTIONAL, -- Need R

| | |
|---|---|
| interFreqBlackCellList | InterFreqBlackCellList |

OPTIONAL, -- Need R
...
}
InterFreqCarrierFreqInfo-v1610 ::= SEQUENCE {

| | |
|---|---|
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqWhiteCellList-r16 | InterFreqWhiteCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) OF |
| InterFreqCAG-CellListPerPLMN-r16 | OPTIONAL -- Need R |

}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) |

OF InterFreqNeighCellInfo-v1610

| | |
|---|---|
| InterFreqNeighCellInfo ::= | SEQUENCE { |
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

OPTIONAL, -- Need R
...
}

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| InterFreqBlackCellList ::= | SEQUENCE (SIZE (1..maxCellBlack)) OF |

PCI-Range

| | |
|---|---|
| InterFreqWhiteCellList-r16 ::= | SEQUENCE (SIZE (1..maxCellWhite)) OF |

PCI-Range
InterFreqCAG-CellListPerPLMN-r16 ::= SEQUENCE

| | |
|---|---|
| plmn-IdentityIndex-r16 | INTEGER (1..maxPLMN), |
| cag-CellList-r16 | SEQUENCE (SIZE (1..maxCAG-Cell-r16)) OF |

PCI-Range
}

The SIB5 may include the information/parameters for the UE to reselect the inter-RAT frequency cell. For example, one or more EUTRA frequencies may be broadcast through the SIB5, and one cell reselection priority configuration information for each EUTRA frequency may be broadcast. The cell reselection priority configuration information for each EUTRA frequency means the contents described above, for example, cellReselectionPriority and/or cellReselectionSubPriority mapped to each EUTRA frequency, but has the characteristic that one cell reselection priority configuration information for each EUTRA frequency is optionally included in the SIB. Specifically, the SIB5 may include information of Table 5 below.

TABLE 5

| | |
|---|---|
| SIB5 ::= | SEQUENCE { |

| | |
|---|---|
| carrierFreqListEUTRA | CarrierFreqListEUTRA |

OPTIONAL, -- Need R

| | |
|---|---|
| t-ReselectionEUTRA | T-Reselection, |

| | |
|---|---|
| t-ReselectionEUTRA-SF | SpeedStateScaleFactors |

OPTIONAL, -- Need S

| | | |
|---|---|---|
| lateNonCriticalExtension | OCTET STRING | OPTIONAL, |

...,
[[

| | |
|---|---|
| carrierFreqListEUTRA-v1610 | CarrierFreqListEUTRA-v1610 |

OPTIONAL -- Need R
]]
}

| | |
|---|---|
| CarrierFreqListEUTRA ::= | SEQUENCE (SIZE (1..maxEUTRA- |

Carrier)) OF CarrierFreqEUTRA

| | |
|---|---|
| CarrierFreqListEUTRA-v1610 ::= | SEQUENCE (SIZE (1..maxEUTRA- |

Carrier)) OF CarrierFreqEUTRA-v1610

| | |
|---|---|
| CarrierFreqEUTRA ::= | SEQUENCE { |
| carrierFreq | ARFCN-ValueEUTRA, |

| | |
|---|---|
| eutra-multiBandInfoList | EUTRA-MultiBandInfoList |

OPTIONAL, -- Need R

| | |
|---|---|
| eutra-FreqNeighCellList | EUTRA-FreqNeighCellList |

OPTIONAL, -- Need R

| | |
|---|---|
| eutra-BlackCellList | EUTRA-FreqBlackCellList |

OPTIONAL, -- Need R

| allowedMeasBandwidth | EUTRA-AllowedMeasBandwidth, | |
|---|---|---|
| presenceAntennaPort1 | EUTRA-PresenceAntennaPort1, | |
| cellReselectionPriority | CellReselectionPriority | OPTIONAL, |

-- Need R

| | |
|---|---|
| cellReselectionSubPriority | CellReselectionSubPriority |

OPTIONAL, -- Need R

| | |
|---|---|
| threshX-High | ReselectionThreshold, |
| threshX-Low | ReselectionThreshold, |
| q-RxLevMin | INTEGER (−70..−22), |
| q-QualMin | INTEGER (−34..−3), |
| p-MaxEUTRA | INTEGER (−30..33), |
| threshX-Q | SEQUENCE { |
| threshX-HighQ | ReselectionThresholdQ, |
| threshX-LowQ | ReselectionThresholdQ |

| | |
|---|---|
| } | OPTIONAL -- Cond |

RSRQ
}
CarrierFreqEUTRA-v1610 ::= SEQUENCE {

| | |
|---|---|
| highSpeedEUTRACarrier-r16 | ENUMERATED {true} |

OPTIONAL -- Need R
}

| | |
|---|---|
| EUTRA-FreqBlackCellList ::= | SEQUENCE (SIZE (1..maxEUTRA- |

CellBlack)) OF EUTRA-PhysCellIdRange

| | |
|---|---|
| EUTRA-FreqNeighCellList ::= | SEQUENCE (SIZE |

(1..maxCellEUTRA)) OF EUTRA-FreqNeighCellInfo

| EUTRA-FreqNeighCellInfo ::= | SEQUENCE { | |
|---|---|---|
| physCellId | EUTRA-PhysCellId, | |
| dummy | EUTRA-Q-OffsetRange, | |
| q-RxLevMinOffsetCell | INTEGER (1..8) | OPTIONAL, |

-- Need R

| | | |
|---|---|---|
| q-QualMinOffsetCell | INTEGER (1..8) | OPTIONAL |

-- Need R
}

The UE 1e-01 in the RRC idle mode or the RRC inactive mode may perform the cell reselection evaluation process. The cell reselection evaluation process may mean a series of processes including determining reselection priorities handling, performing frequency measurement by applying measurement rules for cell reselection according to the determined reselection priorities, and evaluating cell reselection criteria according to the measurement to reselect a cell.

In step 1e-40, the UE 1e-01 in the RRC idle mode or the RRC inactive mode may derive the reselection priority based on the system information received in step 1e-25.

The UE may determine the reselection priority only for a frequency for which a cell reselection priority value is broadcast in the system information. The UE according to the present disclosure may determine, based on the cell reselection priority value mapped to the NR frequency to which a serving cell currently camped-on belongs, whether the cell reselection priorities for each NR inter-frequency or inter-RAT frequency have the same cell reselection priority as the NR frequency to which the serving cell belongs, has the cell reselection priority higher than the NR frequency to which the serving cell belongs, or has the cell reselection priority lower than the NR frequency to which the serving cell belongs. For example, in the system information acquired in step 1e-25, when the cell reselection priority value mapped to the NR frequency to which the serving cell currently camped-on belongs is 3, the cell reselection priority value of the inter NR frequency 1 is 2, the cell reselection priority value of the inter NR frequency 2 is 3, the cell reselection priority value of the inter NR frequency 3 is 4, and the cell reselection priority value of the EUTRA frequency 1 is 2, the UE may determine the inter NR frequency 1 and the EUTRA frequency 1 as a lower reselection priority, determine the inter NR frequency 2 as an equal reselection priority, and determine the cell reselection priority of the inter NR frequency 3 as a higher reselection priority.

In step 1e-45, the UE 1e-01 in the RRC idle mode or the RRC inactive mode may perform the frequency measurement for cell reselection. In this case, the UE may perform the frequency measurement using the following measurement rule according to the cell reselection priority determined in step 1e-40 to minimize battery consumption.
When the following condition 1 is fulfilled, the UE may not perform the NR intra-frequency measurement. If not (e.g., when the following condition 1 is not fulfilled), the UE performs the NR intra-frequency measurement.
Condition 1: A reception level Srxlev of the serving cell is greater than an SIntraSearchP threshold and a reception quality Squal of the serving cell is greater than an SIntraSearchQ threshold (serving cell fulfills Srxlev>SIntraSearchP and Squal>SIntraSearchQ).
The UE may perform measurement on the NR inter-frequency or an inter-RAT frequency with a higher reselection priority than an NR frequency of a current serving cell according to the 3GPP TS 38.133 standard.
For an NR inter-frequency with a reselection priority lower than or equal to an NR frequency of a current serving cell, and an inter-RAT frequency with a reselection priority lower than the NR frequency of the current serving cell, the UE may not perform the measurement if Condition 2 below is fulfilled. If not (e.g., if Condition 2 below is not fulfilled), the UE measures cells in an NR inter-frequency with a reselection priority lower than or equal to the NR frequency, or cells in an inter-RAT frequency having a reselection priority lower than the NR frequency.
Condition 2: The reception level Srxlev of the serving cell is greater than the SnonIntraSearchP threshold, and the reception quality Squal of the serving cell is greater than the SnonIntraSearchQ threshold (Serving cell fulfills Srxlev>SnonIntraSearchP and Squal>SnonIntraSearchQ).

For reference, the above-described thresholds (SintraSearchP, SintraSearchQ, SnonIntraSearchP, and SnonintraSearchQ) may be broadcast in the system information acquired in step 1e-25.

In step 1e-50, the UE 1e-01 in the RRC idle mode or the RRC inactive state may determine to reselect a cell fulfilling cell reselection criteria based on the measurement value performed in step 1e-45. Different criteria may be applied to the cell reselection criteria according to the cell reselection priority. Cell reselection to a higher priority RAT/frequency shall take precede over a lower priority RAT/frequency if multiple cells of different priorities fulfill the cell reselection criteria.

More specifically, the operation of the UE for the reselection criteria of the inter-frequency/inter-RAT cell with the higher priority than the frequency of the current serving cell is as follows:

### First Operation

When the SIB2, which includes a threshold for threshServingLowQ, is broadcast, and one second has passed since the UE camped-on the current serving cell, the signal quality Squal of the inter-frequency/inter-RAT cell is greater than the threshold Thresh_{X,HighQ} during a specific time interval Treselection_{RAT} (Squal>Thresh_{X,HighQ} during a time interval Treselection-_{RAT}), the UE performs the reselection to the corresponding inter-frequency/inter-RAT cell.

### Second Operation

When the UE does not perform the first operation, the UE performs a second operation.
When one second has passed since the UE camped-on the current serving cell and the reception level Srxlev of the inter-frequency/inter-RAT cell is greater than the threshold Thresh_{X,HighQ} during the specific time interval Treselection_{RAT} (Srxlev>Thresh_{X,HighP} during a time interval Treselection-_{RAT}), the UE performs the reselection to the corresponding inter-frequency/inter-RAT cell.

Here, the UE performs the first or second operation based on the information included in the SIB4 broadcast by the serving cell, such as the signal quality Squal, the reception level Srxlev, the thresholds Threh_{X,HighQ} and Thresh_{X,HighP}, and the Treselection_{RAT} value of the inter-frequency cell, and performs the first or second operation based on the information included in the SIB5 broadcast by the serving cell, such as the signal quality Squal, the reception level Srxlev, the thresholds Thresh_{X,HighQ} and Thresh_{X,HighP}, and the Treselection_{RAT} values of the inter-RAT cell. For example, the SIB4 includes a Q_{qualmin} value, a Qᵣₓₗₑᵣₘᵢₙ value, etc., and the signal quality Squal or reception level Srxlev of the inter-frequency cell is derived based on the Q_{qualmin} value and the Qᵣₓₗₑᵣₘᵢₙ value, etc. When there are multiple cells in the NR frequency fulfilling the high cell reselection priority, the UE may reselect the highest ranked cell from among the cells fulfilling the intra-frequency/inter-frequency cell reselection criteria having the same priority as the frequency of the current serving cell described below.

In addition, the operation of the UE for the intra-frequency/inter-frequency cell reselection criteria having the same priority as the frequency of the current serving cell is as follows.

### Third Operation

When the signal quality Squal and the reception level Srxlev of the intra-frequency/inter-frequency cell are greater than 0, the cell-specific rank is derived based on the measurement value (RSRP) (The UE shall perform ranking of all cells that fulfills the cell selection criterion S). The ranks of the serving cell and the neighboring cells are each calculated using the following Mathematical Expression 2.

$${R}_{s} = {Q}_{meas , s} + {Q}_{hyst} \qquad Mathematical Expression 2$$

$${R}_{n} = {Q}_{meas , n} - Offset$$

Here, Q_{meas,s} denotes the RSRP measurement value of the serving cell, Q_{meas,n} denotes the RSRP measurement value of the neighboring cell, Q_{hyst} denotes a hysteresis value of the serving cell, and Qoffset denotes an offset between the serving cell and the surrounding cells. The Q_{hyst} value is included in the SIB2, and the corresponding value is commonly used for the intra-frequency/inter-frequency cell reselection. In case of the intra-frequency cell reselection, the Qoffset is signaled for each cell, applied only to the indicated cell, and included in the SIB3. In case of the inter-frequency cell reselection, the Qoffset is signaled for each cell, applied only to the indicated cell, and included in the SIB4. In the case where the rank of the neighboring cells obtained from the above Mathematical Expression 2 is greater than the rank of the serving cell (R-n>Rs), the optimal cell is reselected from among the neighboring cells.

In addition, the operation of the UE for the reselection criteria of the inter-frequency/inter-RAT cell with the lower priority than the frequency of the current serving cell is as follows:

### Fourth Operation

When the SIB2 includes and broadcast the threshold for threshServingLowQ and one second has passed since the UE camped-on the current serving cell, the signal quality Squal of the current serving cell is smaller than the threshold Thresh_{Serving,LowQ} (Squal<Thresh_{Serving,LowQ}) and the signal quality Squal of the inter-frequency/inter-RAT cell is greater than the threshold Thresh_{X,LowQ-} during the specific time interval Treselection_{RAT} (Squal>Thresh_{X,HighQ} during a time interval Treselection-_{RAT}), the UE performs the reselection to the corresponding inter-frequency/inter-RAT cell.

### Fifth Operation

When the UE does not perform the fourth operation, the UE performs a fifth operation.
When one second has passed since the UE camped-on the current serving cell and the reception level Srxlev of the current serving cell is smaller than the threshold Thresh_{Serving,LowP} (Srxlev<Thresh_{Serving,LowP}) and the reception level Srxlev of the inter-frequency/inter-RAT cell is greater than the threshold Thresh_{X,LowQ-} during the specific time interval Treselection_{RAT} (Srxlev>Thresh_{X,LowP} during a time interval Treselection_{RAT}), the UE performs the reselection to the corresponding inter-frequency/inter-RAT cell.

Here, the fourth or fifth operation for the inter-frequency cell of the UE is performed based on the thresholds Thresh_{Serving,LowQ} and Thresh_{Serving,LowP} included in the SIB2 broadcast by the serving cell and the signal quality Squal, the reception level Srxlev, the thresholds Threh_{X,LowQ} and Thresh_{X,LowP}, and the Treselection_{RAT} of the inter-frequency cell included in the SIB4 broadcast by the serving cell, and the fourth or fifth operation for the inter-RAT cell of the UE is performed based on the thresholds Thresh_{Serving,LowQ} and Thresh_{Serving,LowP} included in the SIB2 broadcast by the serving cell and the signal quality Squal, the reception level Srxlev, the thresholds Thresh_{X,LowQ} and Thresh_{X,LowP}, and the Treselection_{RAT} of the inter-RAT cell included in the SIB5 broadcast by the serving cell. For example, the SIB4 includes a Q_{qualmin} value, a Q_{rxdevmin} value, etc., and the signal quality Squal or reception level Srxlev of the inter-frequency cell is derived based on the Q_{qualmin} value and the Q_{rxdevmin} value. When there are multiple cells in the NR frequency fulfilling the high cell reselection priority, the UE may reselect the highest ranked cell from among the cells fulfilling the intra-frequency/inter-frequency cell reselection criteria having the same priority as the frequency of the current serving cell described below. Of course, when one candidate cell is derived by fulfilling the above-described condition in a frequency that has a higher or lower priority than the frequency of the current serving cell, the UE may reselect the derived one candidate cell as the best cell (strongest cell).

In step 1e-55, the UE 1e-01 in the RRC idle mode or the RRC inactive state receives system information (e.g., MIB or SIB1) broadcast by a candidate target cell before finally reselecting a candidate target cell, and determines whether the reception level Srxlev and the reception quality Squal of the candidate target cell fulfill a cell selection criterion (Srxlev>0 AND Squal>0) called S-criterion (Mathematical Expression 1) based on the received system information. When the UE fulfills Mathematical Expression 1 and the candidate target cell is suitable, the UE may reselect the candidate target cell.

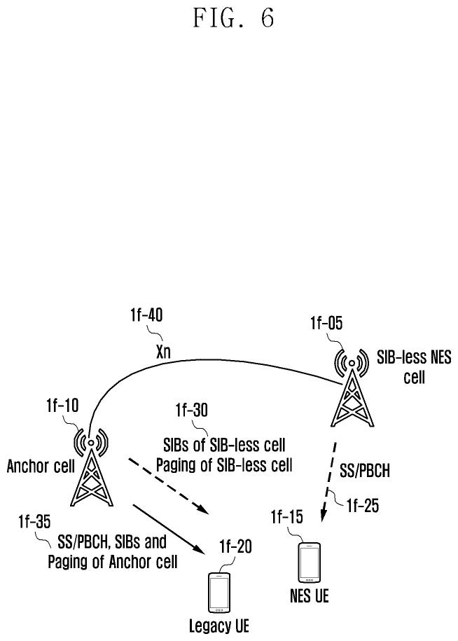

FIG. 6 illustrates a concept of SIB-less network energy saving (NES) according to one embodiment of the present disclosure.

An SIB-less NES cell 1f-05 means a cell that does not transmit the SIB for the purpose of saving power consumption of network equipment. In addition, the cell may not transmit the paging message. Instead, an anchor cell 1f-10 located around the SIB-less NES cell transmits an SIB and/or Paging message (1f-30) of the SIB-less NES cell. The SIB-less NES cell and the anchor cell are connected to each other through a predetermined interface (e.g., Xn) and transmit and receive necessary predetermined information (1f-40).

In the embodiment of the present disclosure, it is assumed that the SIB-less NES cell still broadcasts a synchronization signal block (SSB) and MIB (i.e., SS/PBCH, 1f-25). A network energy saving (NES) UE 1f-15 that may access the SIB-less NES cell may determine whether the cell is the SIB-less NES cell through the predetermined information stored in the MIB broadcast by the SIB-less NES cell, and may access the SIB-less NES cell by acquiring the SIB and paging of the SIB-less NES cell from the neighboring anchor cell. Therefore, the SIB-less NES cell may be called a non-anchor NES cell without SIB.

A legacy UE 1f-20 may not distinguish between the SIB-less NES cell and the existing cell. However, the legacy UE 1f-20 will consider the cell as barred because the SIB-less NES cell is not broadcasting the SIB. Alternatively, the SIB-less NES cell may barred so that the legacy UE 1f-20 does not perform the cell (re) selection on the cell through the legacy information stored in the MIB of the SIB-less NES cell.

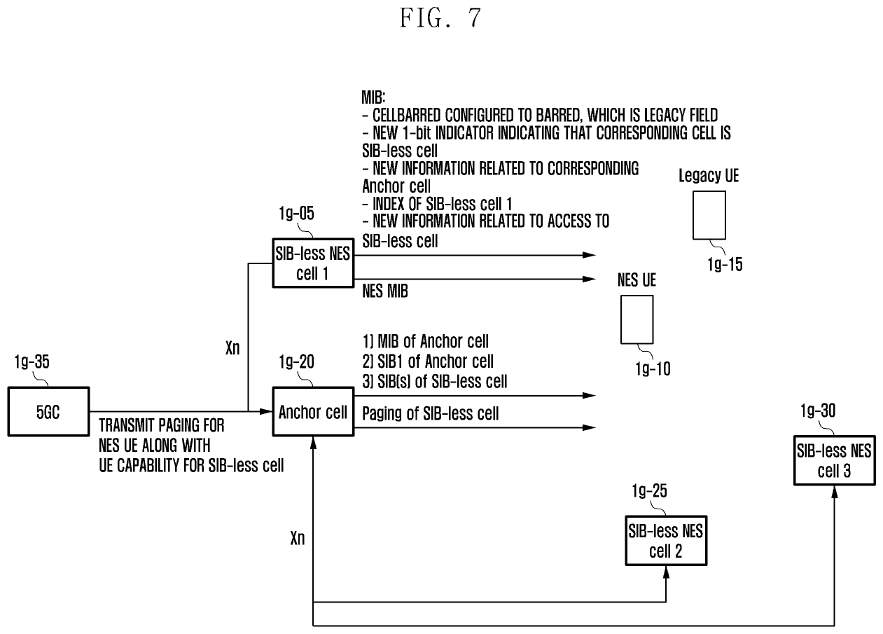

FIG. 7 is illustrates an operation of receiving SIB and paging of an SIB-less NES cell through an anchor cell according to an embodiment of the present disclosure.

An SIB-less NES cell 1 1g-05 broadcasts the SSB and/or MIB. The legacy MIB includes the following information (see the excerpt from TS38.331 ASN.1 below).

ASN1START
TAG-MIB-START

| MIB ::= | SEQUENCE { | |
|---|---|---|
| systemFrameNumber | BIT STRING (SIZE (6)), | |
| subCarrierSpacingCommon | | ENUMERATED {scs15or60, |

scs30or120},

| | |
|---|---|
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
TAG-MIB-STOP
-- ASN1STOP

In this case, the SIB-less NES cell 1 1g-05 may configure a cellBarred field of the MIB to ‘barred’ to prevent legacy UEs Ig-15 from camping-on the cell. The MIB has a spare bit of 1 bit. The spare bit of the MIB may be used as an indicator (e.g., noSIBNESCell) to indicate to NES UEs 1g-10, which may support the SIB-less NES cell or access the SIB-less NES cell, whether the cell is the SIB-less NES cell. In this case, if the indicator indicating that the cell is the SIB-less NES cell is included in the MIB, the NES UEs 1g-10 may ignore the legacy cellBarred field information. That is, even if the legacy cellBarred field is configured to ‘barred’, the NES UEs 1g-15 do not consider the corresponding cell as barred. The MIB includes unnecessary information in the SIB-less NES cell. That is, fields such as subCarrierSpacingCommon, ssb-subcarrierOffset, dmrs-TypeA-Position, and pdcch-ConfigSIB1, which are information required for subsequent operations such as SIB1 reception after MIB reception, are unnecessary in the SIB-less NES cell. Therefore, in the present embodiment, bits allocated to the fields are not used for their original purposes, but are used to indicate SIB-less cell and anchor cell-related information corresponding to the SIB-less cell.

The SIB-less NES cell and anchor cell-related information included in the MIB may include at least one of the following pieces of information.
Index or ID information of the corresponding SIB-less NES cell. One Anchor cell may transmit SIB and paging of one or more SIB-less NES cells. Therefore, in this case, one index or ID information (e.g., physical cell ID (PCI), cell global ID (CGI), etc.) is required to distinguish each SIB-less NES cell corresponding to the anchor cell. In addition, an ID (tracking area code (TAC) or tracking area ID (TAI)) of a tracking area of the corresponding SIB-less NES cell and the ID information of an RAN-based notification area.
Random access radio resource information. For a certain purpose, the NES UE may perform random access to the SIB-less NES cell without communicating with the anchor cell (e.g., receiving paging indicating access to the SIB-less NES cell, etc.). The above-described certain purpose may mean a case where the NES UE may not find an anchor cell fulfilling a predetermined signal strength quality around the SIB-less NES cell, a case where access is triggered for an emergency call, when access is triggered for tacking area update (TAU) or RAN-based notification area (RNA) update, a case where an upper layer entity requests to establish or resume a connection, or a case where a signal is transmitted requesting activation of a base station in a sleep mode for power saving purposes, etc. The random access radio resource information may include, for example, radio resource information, etc., in the time and frequency axes at which the NES UE may transmit a preamble to the SIB-less NES cell. The preamble may be a dedicated preamble according to the certain purpose. For example, among a total of 64 preambles, first to 32th preambles may be used when the NES UE may not find the anchor cell fulfilling the predetermined signal strength quality around the SIB-less NES cell.
Information required to access the anchor cell. The information may be one of the following pieces of information. There may be ID information (e.g., PCI and CGI, etc.) or the frequency information (e.g., ARFCN-ValueNR, etc.) of the anchor cell corresponding to the SIB-less NES cell, some information (e.g., subCarrierSpacingCommon, ssb-subcarrierOffset, dmrs-TypeA-Position, pdcch-ConfigSIB1 information, etc.) included in the MIB of the anchor cell to quickly acquire the SIB1 broadcast by the anchor cell, threshold information (if the received signal strength of the anchor cell is lower than the threshold, the NES UE may consider the anchor cell as invalid) of the minimum received signal strength required to camp-on the anchor cell, etc.

In addition, the information required to access the anchor cell may include a new cellBarred field and/or intraFreqReselection field to prevent the NES UE from camping-on the SIB-less NES cell.
Information required to receive a new NES MIB. Even if legacy fields in a legacy MIB are used to store the new information, the number of bits required to include the new information may be insufficient. Therefore, a dedicated NES MIB that is broadcast only by the SIB-less NES cell may be defined separately. The NES MIB may include new information related to the SIB-less NES cell and the anchor cell mentioned in the present embodiment. The NES MIB may be broadcast according to a predetermined scheduling, or the MIB may include scheduling information for the NES MIB. When the NES MIB is broadcast according to a predetermined scheduling, an indicator indicating that the NES MIB is being broadcast may be included in the legacy MIB broadcast by the SIB-less NES cell.

An anchor cell 1g-20 broadcasts its own MIB and SIB(s) according to the conventional technology. In addition, the anchor cell 1g-20 may also broadcast the MIB of one or more SIB-less NES cells. The anchor cell may also broadcast the SIB of one or more SIB-less NES cells 1g-05, 1g-25, and 1g-30, and may utilize an on-demand SI scheme to effectively provide the SIB to the NES UE. The SIB1 or a new SIB of the anchor cell, or some configuration information of the SIB1 may broadcast including scheduling information of SI messages composed of the SIB(s) of the SIB-less NES cell(s). The scheduling information may include an indicator indicating whether each SI message of the current SIB-less NES cell(s) is being broadcast. In addition, index information indicating to which SIB-less NES cell each SI message or a group of predetermined SI messages corresponds may be included. The SIB1 or a new SIB of the anchor cell, or some configuration information of the SIB1 may include information on SIB-less NES cells managed by the anchor cell. The information on the SIB-less NES cells may include ID information (e.g., PCI, CGI, etc.), index information, frequency information (e.g., ARFCN-ValueNR, etc.), plmn-IdentityInfoList information, etc., of the SIB-less NES cell. Additionally, the anchor cell may provide, as the information on the SIB-less NES cells, threshold information (e.g., QrxlevminNES and/or QqualminNES and/or QrxlevminoffsetNESCell and/or QqualminoffsetNESCell) of the minimum received signal strength required for the NES UE to access the SIB-less NES cell.

The anchor cell may belong to the same tracking area (TA) or RAN-based notification area (RNA) as the SIB-less NES cell(s). A core network 5GC 1g-35 of NR transmits paging for the NES UE to the anchor cell, along with a capability indicator indicating whether the UE is the NES UE or a capability indicator indicating whether the UE supports the SIB-less NES cell. The anchor cell that has received the paging transmits the paging message to the NES UE. In this case, the anchor cell may determine whether the corresponding UE should access the anchor cell or a specific SIB-less NES cell.

The paging message is common signaling, and each paging record in the paging message may include an indicator indicating that access is attempted to a specific SIB-less NES cell, not the anchor cell. The indicator may indicate a specific SIB-less NES cell (among multiple SIB-less NES cells) to which the NES UE should attempt to access. Alternatively, the paging message dedicated to the NES UE that only the NES UE receives may be defined separately. Scheduling information (e.g., paging cycle, etc.) of the NES UE-dedicated paging message may be provided in the SIB1 of the anchor cell.

The NES UE that has received the paging message including the indicator may determine whether to attempt to access the anchor cell that transmits the paging message or to attempt to access a specific SIB-less NES cell. When the UE performs a random access to a specific SIB-less NES cell, the required radio resource information of the random access is included in a specific SIB of the anchor cell broadcast by the anchor cell or a specific SIB of the SIB-less NES cell broadcast by the anchor cell. Meanwhile, even if there is an instruction to attempt access to a specific SIB-less NES cell in the paging message, the NES UE may attempt access to the anchor cell in a certain case. The certain case are a case where the signal strength/quality of the indicated SIB-less NES cell does not fulfill a specific threshold, so the random access is not successfully completed in the SIB-less NES cell, or it is considered that general service may not be provided, or a case where the SIB of the SIB-less NES cell is not acquired in advance, so a long delay time is expected to be consumed until access completion. The specific threshold may be provided through the MIB or NES MIB of the corresponding SIB-less NES cell or the SIB of the corresponding SIB-less cell provided by the anchor cell.

The NES UE may perform the random access on the anchor cell. In this case, the NES UE uses the random access radio resource indicated in the SIB1 of the anchor cell for the random access. The NES UE may report, to the anchor cell, information about neighboring SIB-less cells (e.g., ID information, frequency information, PCI, CGI or index, received strength measurement information, RSRP/RSRQ, etc. of the SIB-less cell) that the NES UE can be connected to or that the NES UE detects via a predetermined uplink message (e.g., Msg3) during a random access process or a predetermined RRC message (e.g., RRCSetupComplete, RRCResumeComplete message, etc.) after the random access process. In addition, when the random access is performed on the anchor cell, not the configured SIB-less NES cell, a cause value indicating the reason may be reported to the anchor cell via a Msg3 message or a predetermined RRC message.

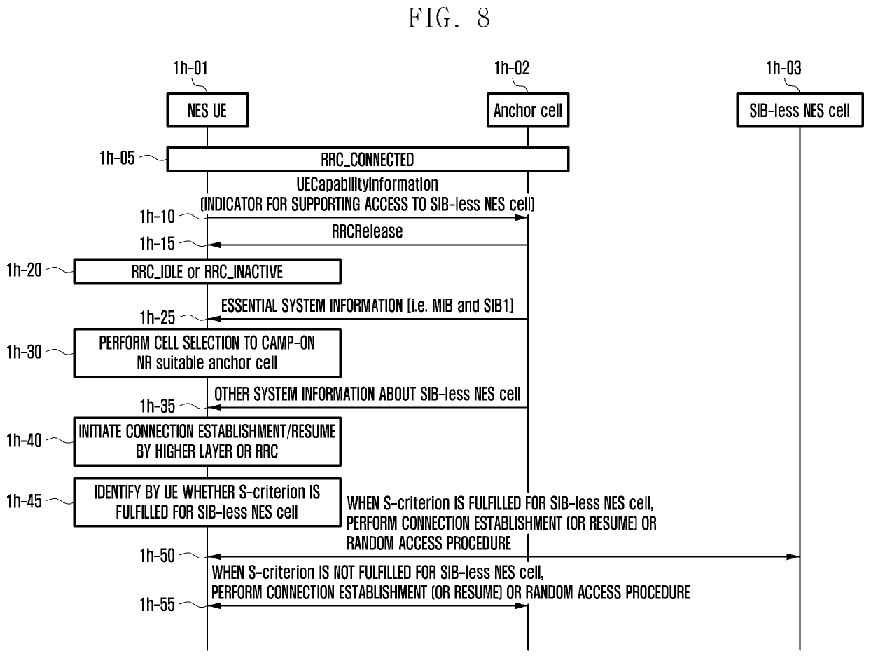

FIG. 8 illustrates a method for an NES UE to access an SIB-less NES cell according to an embodiment of the present disclosure.

In an embodiment of the present disclosure, the NES UE that camps-on the anchor cell or uses the anchor cell as the serving cell may access the SIB-less NES cell. That is, when the NES UE accesses the SIB-less NES cell, the NES UE may not camp-on the SIB-less NES cell or reselect the SIB-less NES cell. When the NES UE may reselect the SIB-less NES cell, the method for an NES UE to access an SIB-less NES cell may follow the above-described cell reselection-related embodiment, but there may be a difference in that the SIB-less NES cell is reselected based on the information provided by the anchor cell.

When evaluating Srxlev and Squal of non-serving cells for reselection evaluation purposes, the UE shall use parameters provided by the serving cell and for the final check on cell selection criterion for SIB-less NES cell, the UE shall use parameters provided by the anchor cell for cell reselection.

Referring to FIG. 8, an NES UE 1h-01 may be in an RRC connection mode by establishing an RRC connection with an anchor cell 1h-02 (1h-05).

In step 1h-10, the NES UE 1h-01 may transmit a UE capability information message (UECapabilityInformation) to the anchor cell 1h-02. The message may include capability information indicating that the NES UE 1h-01 may access the SIB-less NES cell. For reference, even if the UE supports the capability of accessing the SIB-less NES cell, the capability information may not be transmitted separately to the base station.

In step 1h-15, the anchor cell 1h-02 may transmit an RRC connection release message (RRCRelease) to the NES UE 1h-01. This may follow the above-described embodiment.

In step 1h-20, the NES UE 1h-01 may transition to an RRC idle mode (RRC_IDLE) or an RRC inactive mode (RRC_INACTIVE).

In step 1h-25, the NES UE 1h-01 may acquire essential system information from the anchor cell 1h-02. Here, the essential system information may mean the master information block (MIB) and the system information block 1 (SIB1).

In step 1h-30, the UE 1h-01 in the RRC idle mode or the RRC inactive mode may perform the cell selection procedure to camp-on an NR suitable anchor cell 1h-02. In the present disclosure, the cell which the NES UE camps-on may be referred to as the anchor cell. For reference, the anchor cell may explicitly indicate that it is the anchor cell through the SIB1, the legacy system information, or new system information, or may be implicitly indicated as an anchor cell by including system information storing information required for specific SIB-less NES cell(s) in scheduling information. For reference, in step 1h-30, the anchor cell may also become the serving cell of the UE even through the cell reselection according to the above-described embodiment.

In step 1h-35, the NES UE 1h-01 in the RRC idle mode or the RRC inactive mode may acquire the system information including the information required for access to the SIB-less NES cell 1h-03 from the anchor cell 1h-02. For example, the anchor cell 1h-02 may periodically broadcast the SIB1 for the SIB-less NES cell, or may broadcast the SIB1 (on-demand SI broadcast) upon UE request. The SIB1 information for the SIB-less NES cell may be as shown in Table 6 below. For reference, only a part of the SIB1 information below may be defined and included.

TABLE 6
SIB1 ::= SEQUENCE {

| | |
|---|---|
| cellSelectionInfo | SEQUENCE { |
| q-RxLevMin | Q-RxLevMin, |

| | |
|---|---|
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | | |
|---|---|---|
| q-QualMin | Q-QualMin | OPTIONAL, |

-- Need S

| | | |
|---|---|---|
| q-QualMinOffset | INTEGER (1..8) | OPTIONAL |

-- Need S

| | |
|---|---|
| } | OPTIONAL, |

-- Cond Standalone

| | |
|---|---|
| cellAccessRelatedInfo | CellAccessRelatedInfo, |

| | |
|---|---|
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |

| | |
|---|---|
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC-AccessCategory1-SelectionAssistanceInfo, |
| individualPLMNList | SEQUENCE (SIZE (2..maxPLMN)) OF UAC- |

AccessCategory 1-SelectionAssistanceInfo

| | |
|---|---|
| } | OPTIONAL - |

- Need S

| | |
|---|---|
| } | OPTIONAL, |

-- Need R

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL
}

| | |
|---|---|
| SIB1-v1610-IEs ::= | SEQUENCE { |

| | |
|---|---|
| idleModeMeasurementsEUTRA-r16 | ENUMERATED{true} |

OPTIONAL, -- Need R

| | |
|---|---|
| idleModeMeasurementsNR-r16 | ENUMERATED{true} |

OPTIONAL, -- Need R

| | |
|---|---|
| posSI-SchedulingInfo-r16 | PosSI-SchedulingInfo-r16 |

OPTIONAL, -- Need R

| | |
|---|---|
| nonCriticalExtension | SIB1-v1630-IEs |

OPTIONAL
}

| | |
|---|---|
| SIB1-v1630-IEs ::= | SEQUENCE { |
| uac-BarringInfo-v1630 | SEQUENCE { |
| uac-AC1-SelectAssistInfo-r16 | SEQUENCE (SIZE (2..maxPLMN)) OF |

UAC-AC1-SelectAssistInfo-r16

| | |
|---|---|
| } | OPTIONAL, - |

- Need R

| | |
|---|---|
| nonCriticalExtension | SIB1-v1700-IEs |

OPTIONAL
}

| | |
|---|---|
| SIB 1-v1700-IEs ::= | SEQUENCE { |

| | |
|---|---|
| hsdn-Cell-r17 | ENUMERATED {true} |

OPTIONAL, -- Need R

| | |
|---|---|
| uac-BarringInfo-v1700 | SEQUENCE { |
| uac-BarringInfoSetList-v1700 | UAC-BarringInfoSetList-v1700 |

| | |
|---|---|
| } | OPTIONAL, - |

- Cond MINT

| | |
|---|---|
| sdt-ConfigCommon-r17 | SDT-ConfigCommonSIB-r17 |

OPTIONAL, -- Need R

| | |
|---|---|
| redCap-ConfigCommon-r17 | RedCap-ConfigCommonSIB-r17 |

OPTIONAL, -- Need R

| | |
|---|---|
| featurePriorities-r17 | SEQUENCE { |

| | |
|---|---|
| redCapPriority-r17 | FeaturePriority-r17 |

OPTIONAL, -- Need R

| | |
|---|---|
| slicingPriority-r17 | FeaturePriority-r17 |

OPTIONAL, -- Need R

| | |
|---|---|
| msg3-Repetitions-Priority-r17 | FeaturePriority-r17 |

OPTIONAL, -- Need R

| | | |
|---|---|---|
| sdt-Priority-r17 | FeaturePriority-r17 | OPTIONAL |

-- Need R

| | |
|---|---|
| } | OPTIONAL, - |

- Need R

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | |
|---|---|
| eDRX-AllowedIdle-r17 | ENUMERATED {true} |

OPTIONAL, -- Need R

| | |
|---|---|
| eDRX-AllowedInactive-r17 | ENUMERATED {true} |

OPTIONAL, -- Cond EDRX-RC

| | |
|---|---|
| intraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S

| | |
|---|---|
| nonCriticalExtension | SEQUENCE { } |

OPTIONAL
}

| | |
|---|---|
| UAC-AccessCategory1-SelectionAssistanceInfo ::= | ENUMERATED {a, b, |

c}

| | |
|---|---|
| UAC-AC1-SelectAssistInfo-r16 ::= | ENUMERATED {a, b, c, |

notConfigured}

| | |
|---|---|
| SDT-ConfigCommonSIB-r17 ::= | SEQUENCE { |

| | |
|---|---|
| sdt-RSRP-Threshold-r17 | RSRP-Range |

OPTIONAL, -- Need R

| | |
|---|---|
| sdt-LogicalChannelSR-DelayTimer-r17 | ENUMERATED { sf20, sf40, sf64, |

| | |
|---|---|
| sf128, sf512, sf1024, sf2560, spare1} | OPTIONAL, -- Need R |

| | |
|---|---|
| sdt-DataVolumeThreshold-r17 | ENUMERATED {byte32, byte100, |

byte200, byte400, byte600, byte800, byte1000, byte2000, byte4000,
byte8000, byte9000, byte10000, byte12000, byte24000, byte48000,
byte96000},

| | |
|---|---|
| t319a-r17 | ENUMERATED { ms100, ms200, ms300, ms400, |

ms600, ms1000, ms2000,
ms3000, ms4000, spare7, spare6, spare5, spare4, spare3, spare2, spare1}
}
RedCap-ConfigCommonSIB-r17 ::= SEQUENCE {

| | |
|---|---|
| halfDuplexRedCapAllowed-r17 | ENUMERATED {true} |

OPTIONAL, -- Need R

| | |
|---|---|
| cellBarredRedCap-r17 | SEQUENCE { |
| cellBarredRedCap1Rx-r17 | ENUMERATED {barred, notBarred}, |
| cellBarredRedCap2Rx-r17 | ENUMERATED {barred, notBarred} |

| | |
|---|---|
| } | OPTIONAL, - |

- Need R
...
}

Additionally, the information may include threshold information (e.g., QrxlevminNES and/or QqualminNES and/or QrxlevminoffsetNESCell and/or QqualminoffsetNESCell and/or Qrxlemninoffset and/or Qualminoffset) of the minimum received signal strength required for the NES UE 1h-01 to access the SIB-less NES cell 1h-03. Based on the threshold information, at least one of the following conditions should be fulfilled so that the NES UE 1h-01 may access the SIB-less NES cell 1h-03.

$$Srxlev > 0 AND / OR Squal > 0 \qquad Condition 1$$

where:

$$Srxlev = Qrxlevmeas - ( Qrxlevmin + Qrxlevminoffset ) - Pcompensation - Qoffsettemp$$

$$Squal = Qqualmeas - ( Qqualmin + Qqualminoffset ) - Qoffsettemp$$

$$Srxlex > 0 AND / OR Squal > 0 \qquad Condition 2$$

where:

$$Srxlev = Qrxlevmeas - ( Qrxlevmin + QrxlevminNES + Qrxlevminoffset ) - Pcompensation - Qoffsettemp$$

$$Squal = Qqualmeas - ( QqualminNES + Qqualminoffset ) - Qoffsettemp$$

$$Srxlex > 0 AND / OR Squal > 0 \qquad Condition 3$$

where:

$$Srxlev = Qrxlevmeas - ( Qrxlevmin + QrxlevminoffsetNESCell Qrexlevminoffset ) - Pcompensation - Qoffsettemp$$

$$Squal = Qqualmeas - ( Qqualmin + QualminoffsetNESCell + Qqualminoffset ) - Qoffsettemp$$

$$Srxlex > 0 AND / OR Squal > 0 \qquad Condition 4$$

where:

$$Srxlev = Qrxlevmeas - ( QrxlevminNES + QrxlevminoffsetNESCell Qrxlevminoffset ) - Pcompensation - Qoffsettemp$$

$$Squal = Qqualmeas - ( QqualminNES + QqualminoffsetNESCell + Qqualminoffset ) - Qoffsettemp$$

For reference, specific thresholds in the above conditions may be omitted from the above formulas. For example, when Qoffsettemp is not required for the minimum received signal strength required to access the SIB-less NES cell, the Qoffsettemp may be excluded from the above formula conditions. By broadcasting the new threshold, the anchor cell has an advantage in that it may manage whether the NES UE 1h-01 performs access to the anchor cell 1h-02 or access to the SIB-less NES cell 1h-03 (e.g., depending on anchor cell overload). Additionally, since the above formula condition(s) may be fulfilled for one or more SIB-less NES cells 1h-03, the NES UE 1h-01 may determine whether the formula condition(s) are fulfilled only for the SIB-less NES cell with the strongest signal. Alternatively, when the formula condition(s) are not fulfilled for the SIB-less NES cell with the strongest signal, the NES UE 1h-01 may determine whether the formula condition(s) are fulfilled for the SIB-less NES cell with the second strongest signal. Alternatively, the anchor cell 1h-02 may provide the NES UE 1h-01 with information about which SIB-less NES cell of one or more SIB-less NES cells should be accessed preferentially, and thus perform control to prioritize access to the SIB-less NES cell with higher priority that fulfill the above conditions, among the SIB-less NES cells. For reference, the priority information may be provided for each SIB-less NES cell, or may be provided for each frequency. When the priority information is provided for each frequency, the NES UE 1h-01 may apply the above-described contents to a frequency with higher priority to prioritize the access to the SIB-less NES cell. By combining some of the above-described contents, the NES UE 1h-01 may attempt the access to the SIB-less NES cell 1h-03.

In step 1h-40, the connection establishment procedure or the connection resume procedure of the NES UE 1h-01 may be initiated by the higher layer entity of the NES UE 1h-01 or the RRC. For example, the connection establishment procedure or the connection resume procedure may be triggered due to a mobile originating (MO) service, an RAN notification area update (RNAU), etc.

In step 1h-45, the NES UE 1h-01 may determine whether the condition described above in step 1h-35 is fulfilled for the SIB-less NES cell. When the corresponding condition is fulfilled, at step 1h-50, the NES UE 1h-01 may perform the access to the SIB-less NES cell 1h-03. For example, the NES UE 1h-01 may perform the RRC connection establishment procedure, the RRC connection resume procedure, or the random access procedure with the SIB-less NES cell 1h-03. When the NES UE 1h-01 determines that the condition described above in step 1h-35 is not fulfilled for the SIB-less NES cell, in step 1h-55, the NES UE 1h-01 may perform the access to the anchor cell 1h-02. For reference, when the NES UE 1h-01 receives the information from the anchor cell 1h-02 to access the anchor cell 1h-02 or needs to perform the access to only the anchor cell 1h-02 (e.g., when receiving the paging message), the NES UE 1h-01 may perform the access to the anchor cell 1h-02 without accessing the SIB-less NES cell 1h-03.

In the present disclosure, the NES UE 1h-01 performs the access to the SIB-less NES cell 1h-03 when the condition described above in step 1h-35 is fulfilled, and if not, performs the access to the anchor cell 1h-02. Additionally, according to the present disclosure, by providing a new minimum received signal strength threshold for the NES UE 1h-01 to access the SIB-less NES cell 1h-03, the anchor cell 1h-02 may manage whether the NES UE 1h-01 accesses the anchor cell 1h-02 or accesses the SIB-less NES cell 1h-03.

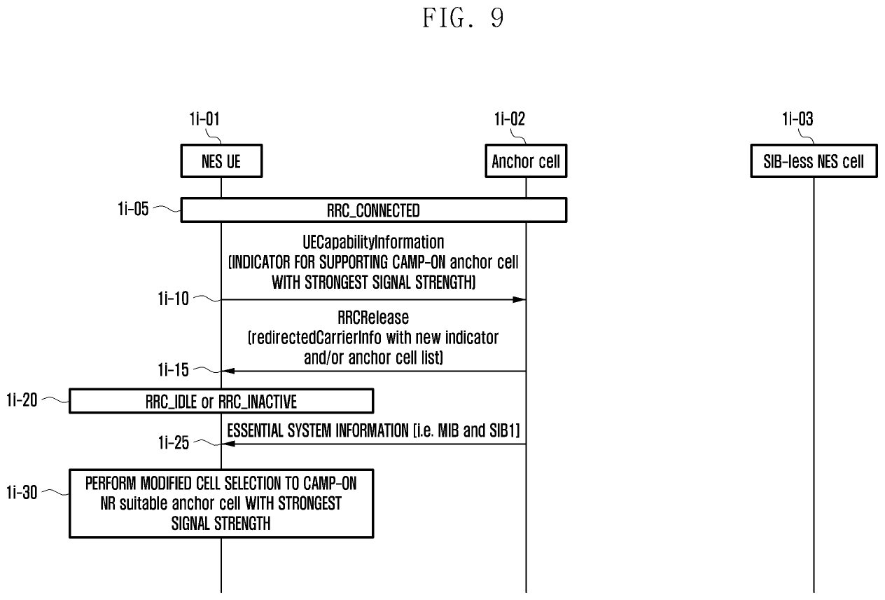

FIG. 9 illustrates a base station to redirect an NES UE to an anchor cell according to an embodiment of the present disclosure.

Referring to FIG. 9, an NES UE 1i-01 may be in an RRC connection mode by establishing an RRC connection with a base station 1i-02 (1i-05).

In step 1i-10, the NES UE 1i-01 may transmit the UE capability information message (UECapabilityInformation) to the anchor cell 1i-02. The message may include the information about the capability of the UE to camp-on the anchor cell when the base station instructs the UE to perform the redirection to the anchor cell using the RRC connection release message. Alternatively, the UE may include the information about the capability to camp-on the strongest anchor cell in the message.

In step 1i-15, the anchor cell 1i-02 may transmit the RRC connection release message (RRCRelease) to the NES UE 1i-01. The message may include redirectionCarrierInfo. The redirectionCarrierInfo may include an NR carrier frequency, a eutra carrier frequency, or a eutra carrier frequency and a network core type (epc or 5GC). Additionally, in the present disclosure, the redirectedCarrierInfo includes at least one of the following information.
An indicator to camp-on the strongest anchor cell: The NES UE may camp-on the anchor cell with the strongest signal at the NR carrier frequency indicated in the redirectionCarrierInfo. That is, the NES UE does not simply camp-on the cell with the strongest signal in the NR carrier frequency, but camps-on the anchor cell with the strongest signal among the anchor cells.
Anchor cell list: The NES UE camps-on the anchor cell with the strongest signal among the cells indicated by the anchor cell list among the NR carrier frequencies indicated in redirectionCarrierInfo.

In step 1i-20, the NES UE 1i-01 may transition to the RRC idle mode (RRC_IDLE) or the RRC inactive mode (RRC_INACTIVE).

In step 1i-25, the NES UE 1i-01 may acquire essential system information from the anchor cell 1i-02. The essential system information may mean the master information block (MIB) and the system information block 1 (SIB1).

In step 1i-30, the NES UE 1i-01 in the RRC idle mode or the RRC inactive mode may perform the cell selection procedure to camp-on an NR suitable strongest anchor cell 1i-02. While the existing cell selection procedure camps-on the cell with the strongest signal at a specific frequency, the NES UE 1i-01 has the characteristic of performing the cell selection procedure according to the above-described contents in (1i-15).

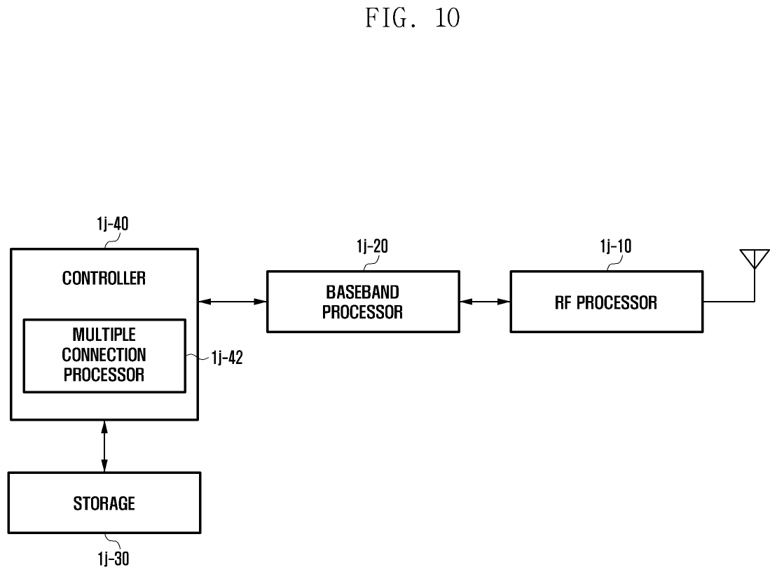

FIG. 10 illustrates a block diagram of an internal structure of a terminal according to an embodiment of the present disclosure.

Referring to FIG. 10, the terminal includes a radio frequency (RF) processor 1j-10, a baseband processor 1j-20, a storage 1j-30, and a controller 1j-40.

The RF processor 1j-10 performs the function of transmitting and receiving the signals through the wireless channel, such as the band conversion and amplification of the signals. The RF processor 1j-10 up-converts a baseband signal provided from the baseband processor 1j-20 into an RF band signal and then transmits the RF band signal through an antenna, and down-converts the RF band signal received through the antenna into the baseband signal. For example, the RF processor 1j-10 may include a transmission filter, a reception filter, an amplifier, a mixer, an oscillator, a digital to analog converter (DAC), an analog to digital converter (ADC), etc. In FIG. 10, only one antenna is illustrated, but the terminal may include a plurality of antennas. In addition, the RF processor 1j-10 may include a plurality of RF chains. Furthermore, the RF processor 1j-10 may perform beamforming. For the beamforming, the RF processor 1j-10 may adjust phases and sizes of each signal transmitted and received through the plurality of antennas or antenna elements. In addition, the RF processor may perform MIMO and may receive a plurality of layers when performing a MIMO operation.

The baseband processor 1j-20 performs a conversion function between a baseband signal and a bit stream according to physical layer specifications of the system. For example, when transmitting data, the baseband processor 1j-20 encodes and modulates a transmission bit stream to generate complex symbols. In addition, when receiving data, the baseband processor 1j-20 reconstructs a reception bit stream by demodulating and deciphering the baseband signal provided from the RF processor 1j-10. For example, in the case of following the orthogonal frequency division multiplexing (OFDM) scheme, when transmitting data, the baseband processor 1j-20 encodes and modulates the transmission bit stream to generate the complex symbols, maps the complex symbols to subcarriers, and then constructs the OFDM symbols through an inverse fast Fourier transform (IFFT) operation and a cyclic prefix (CP) insertion. In addition, when receiving data, the baseband processor 1j-20 segments the baseband signal provided from the RF processor 1j-10 into OFDM symbol units, reconstructs the signals mapped to the subcarriers through fast Fourier transform (FFT), and then reconstructs the reception bit stream through the demodulation and deciphering.

The baseband processor 1j-20 and the RF processor 1j-10 transmit and receive the signals as described above. Accordingly, the baseband processor 1j-20 and the RF processor 1j-10 may be referred to as a transmitter, a receiver, a transceiver, or a communication unit. Furthermore, at least one of the baseband processor 1j-20 and the RF processor 1j-10 may include a plurality of communication modules to support a plurality of different radio access technologies. In addition, at least one of the baseband processor 1j-20 and the RF processor 1j-10 may include different communication modules to process signals in different frequency bands. For example, the different radio access technologies may include wireless LAN (e.g., IEEE 802.11), cellular networks (e.g., LTE), etc. In addition, the different frequency bands may include super high frequency (SHF) (e.g., 2.NRHz, NRhz) bands, and millimeter wave (mm wave) (e.g., 60 GHz) bands.

The storage 1j-30 stores data such as basic programs, application programs, and configuration information for the operation of the terminal. In particular, the storage 1j-30 may store information related to a second access node performing wireless communication using a second radio access technology. In addition, the storage 1j-30 provides the stored data according to a request of the controller 1j-40.

The controller 1j-40 controls the overall operations of the terminal. For example, the controller 1j-40 transmits and receives the signals through the baseband processor 1j-20 and the RF processor 1j-10. In addition, the controller 1j-40 records and reads data in the storage 1j-30. To this end, the controller 1j-40 may include at least one processor. For example, the controller 1j-40 may include a communication processor (CP) that performs control for communication and an application processor (AP) that controls higher layers such as application programs.

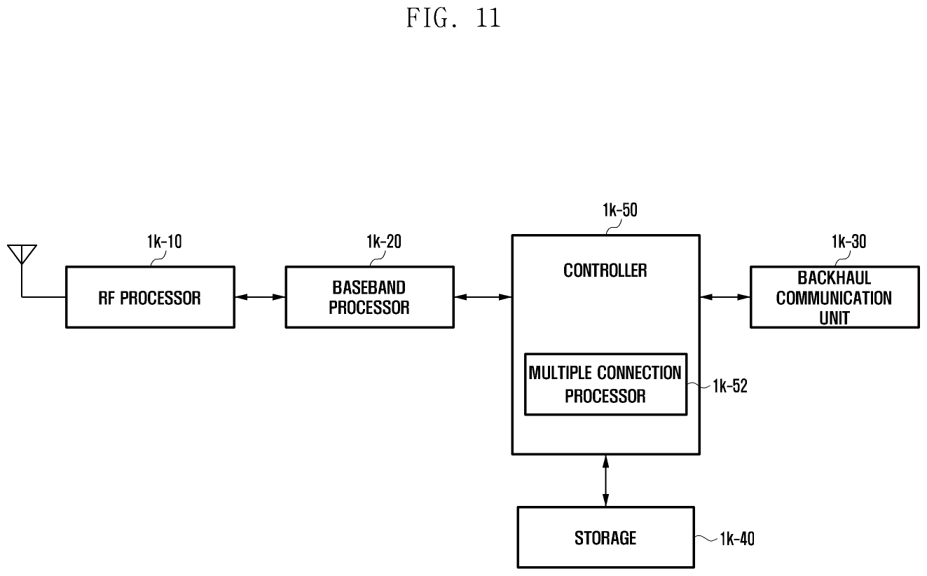

FIG. 11 illustrates a block diagram of a configuration of an NR base station according to an embodiment of the present disclosure.

As illustrated in FIG. 11, the base station is configured to include an RF processor 1k-10, a baseband processor 1k-20, a backhaul communication unit 1k-30, a storage 1k-40, and a controller 1k-50.

The RF processor 1k-10 performs the function of transmitting and receiving signals through a wireless channel, such as band conversion and amplification of the signals. The RF processor 1k-10 up-converts a baseband signal provided from the baseband processor 1k-20 into an RF band signal and then transmits the RF band signal through an antenna, and down-converts the RF band signal received through the antenna into the baseband signal. For example, the RF processor 1k-10 may include a transmission filter, a reception filter, an amplifier, a mixer, an oscillator, a DAC, an ADC, etc. In FIG. 11, only one antenna is illustrated, but the first access node may include a plurality of antennas. In addition, the RF processor 1k-10 may include a plurality of RF chains. Furthermore, the RF processor 1k-10 may perform beamforming. For the beamforming, the RF processor 1k-10 may adjust phases and sizes of each signal transmitted and received through the plurality of antennas or antenna elements. The RF processor may perform a downlink MIMO operation by transmitting one or more layers.

The baseband processor 1k-20 performs the conversion function between the baseband signal and the bit stream according to the physical layer specifications of a first radio access technology. For example, when transmitting data, the baseband processor 1k-20 encodes and modulates a transmission bit stream to generate complex symbols. In addition, when receiving data, the baseband processor 1k-20 reconstructs a reception bit stream by demodulating and deciphering the baseband signal provided from the RF processor 1k-10. For example, in the case of following the OFDM method, when transmitting data, the baseband processor 1k-20 encodes and modulates the transmission bit stream to generate the complex symbols, maps the complex symbols to subcarriers, and then constructs the OFDM symbols through the IFFT operation and the CP insertion. In addition, when receiving data, the baseband processor 1k-20 segments the baseband signal provided from the RF processor 1k-10 into OFDM symbol units, reconstructs the signals mapped to the subcarriers through the FFT operation, and then reconstructs the reception bit stream through the demodulation and deciphering. The baseband processor 1k-20 and the RF processor 1k-10 transmit and receive the signals as described above. Accordingly, the baseband processor 1k-20 and the RF processor 1k-10 may be referred to as a transmitter, a receiver, a transceiver, or a communication unit.

The backhaul communication unit 1k-30 provides an interface for performing communication with other nodes in the network. That is, the backhaul communication unit 1k-30 converts a bit stream transmitted from the main base station to other nodes, such as an auxiliary base station and a core network, into a physical signal, and converts physical signals received from the other nodes into bit streams.

The storage 1k-40 stores data such as basic programs, application programs, and configuration information for the operation of the main base station. In particular, the storage 1k-40 may store information about bearers allocated to an accessed UE, a measurement result reported from the accessed UE, etc. In addition, the storage 1k-40 may store information that serves as a decision criterion for whether to provide multiple connections to the UE or to terminate the multiple connections. In addition, the storage 1k-40 provides the stored data according to a request of the controller 1k-50.

The controller 1k-50 controls the overall operation of the main base station. For example, the controller 1k-50 transmits and receives signals through the baseband processor 1k-20 and the RF processor 1k-10 or through the backhaul communication unit 1k-30. In addition, the controller 1k-50 records and reads data in the storage 1k-40. To this end, the controller 1k-50 may include at least one processor.

In the specific embodiments of the present disclosure described above, components included in the disclosure are expressed in the singular or plural according to the specific embodiments presented. However, the singular or plural expression is appropriately selected for the context presented for convenience of description, and the present disclosure is not limited to the singular or plural components, and even if the component is expressed in plural, the component is configured in singular or even if the component is expressed in singular, the element may be configured in plural.

Meanwhile, the embodiments disclosed in the present specification and drawings described above are provided merely to illustrate and facilitate understanding of the contents of the present disclosure, and are not intended to limit the scope of the disclosure. Therefore, it is to be interpreted that in addition to embodiments of the present disclosure, all modifications or alternations derived based on a technical spirit of the present disclosure are included in the scope of the present disclosure.

1.-15. (canceled)

16. A method performed by a terminal in a wireless communication system, the method comprising:
receiving, from a first cell of a base station, a radio resource control (RRC) release message to transit the terminal from an RRC connected state to an RRC inactive state or an RRC idle state;
receiving, from the first cell of the base station, system information in the RRC inactive state or the RRC idle state, the system information including information for a second cell;
identifying whether a criterion for cell reselection is met; and
in case that the criterion is met, performing a random access procedure with the second cell,
wherein the information for the second cell includes a system information block (SIB) type 1 (SIB1) of the second cell and information on a threshold associated with the criterion.

17. The method of claim 16,
wherein the threshold associated with the criterion includes a reference signal received power (RSRP) threshold or a reference signal received quality (RSRQ) threshold, and
wherein the criterion is estimated based on the threshold associated with the criterion and a synchronization signal block (SSB) received from the second cell.

18. The method of claim 17,
wherein the SSB received from the second cell includes a master information block (MIB) of the second cell, the MIB of the second cell including information indicating that the second cell is an SIB-less network energy saving (NES) cell and information for barring an access from a legacy terminal.

19. The method of claim 16, further comprising:
transmitting, to the first cell of the base station, capability information in the RRC connected state, the capability information including information indicating that the terminal supports to access the SIB-less NES cell.

20. The method of claim 16, further comprising:
in case that the criterion is not met, performing the random access procedure with the first cell based on an SIB1 received from the first cell.

21. A method performed by a base station in a wireless communication system, the method comprising:
transmitting, to a terminal on a first cell, a radio resource control (RRC) release message to transit the terminal from an RRC connected state to an RRC inactive state or an RRC idle state; and
transmitting, to the terminal in the RRC inactive state or the RRC idle state, system information on the first cell, the system information including information for a second cell,
wherein the information for the second cell includes a system information block (SIB) type 1 (SIB1) of the second cell and information on a threshold associated with a criterion for cell reselection.

22. The method of claim 21,
wherein the threshold associated with the criterion includes a reference signal received power (RSRP) threshold or a reference signal received quality (RSRQ) threshold,
wherein, in case that the criterion is met, a random access procedure is performed between the terminal and the second cell, and
wherein, in case that the criterion is not met, the random access procedure is performed between the terminal and the first cell.

23. The method of claim 21, further comprising:
receiving, from the terminal on the first cell, capability information based on the terminal being in the RRC connected state, the capability information including information indicating that the terminal supports an access to an SIB-less network energy saving (NES) cell.

24. A terminal in a wireless communication system, the terminal comprising:
a transceiver; and
a controller configured to:
receive, from a first cell of a base station via the transceiver, a radio resource control (RRC) release message to transit the terminal from an RRC connected state to an RRC inactive state or an RRC idle state,
receive, from the first cell of the base station via the transceiver, system information in the RRC inactive state or the RRC idle state, the system information including information for a second cell,
identify whether a criterion for cell reselection is met, and
in case that the criterion is met, perform a random access procedure with the second cell,
wherein the information for the second cell includes a system information block (SIB) type 1 (SIB1) of the second cell and information on a threshold associated with the criterion.

25. The terminal of claim 24,
wherein the threshold associated with the criterion includes a reference signal received power (RSRP) threshold or a reference signal received quality (RSRQ) threshold,
wherein the criterion is estimated based on the threshold associated with the criterion and a synchronization signal block (SSB) received from the second cell, and
wherein the SSB received from the second cell includes a master information block (MIB) of the second cell, the MIB of the second cell including information indicating that the second cell is an SIB-less network energy saving (NES) cell and information for barring an access from a legacy terminal.

26. The terminal of claim 24, wherein the controller is further configured to transmit, to the first cell of the base station via the transceiver, capability information in the RRC connected state, the capability information including information indicating that the terminal supports an access to the SIB-less NES cell.

27. The terminal of claim 24,
wherein, in case that the criterion is not met, the controller is further configured to perform the random access procedure with the first cell based on an SIB1 received from the first cell.

28. A base station in a wireless communication system, the base station comprising:
a transceiver; and
a controller configured to:
transmit, to a terminal on a first cell, a radio resource control (RRC) release message to transit the terminal from an RRC connected state to an RRC inactive state or an RRC idle state, and
transmit, to the terminal in the RRC inactive state or the RRC idle state, system information on the first cell, the system information including information for a second cell,
wherein the information for the second cell includes a system information block (SIB) type 1 (SIB1) of the second cell and information on a threshold associated with a criterion for cell reselection.

29. The base station of claim 28,
wherein the threshold associated with the criterion includes a reference signal received power (RSRP) threshold or a reference signal received quality (RSRQ) threshold,
wherein, in case that the criterion is met, a random access procedure is performed between the terminal and the second cell, and
wherein, in case that the criterion is not met, the random access procedure is performed between the terminal and the first cell.

30. The base station of claim 28,
wherein the controller is further configured to receive, from the terminal on the first cell, capability information based on the terminal being in the RRC connected state, the capability information including information indicating that the terminal supports an access to an SIB-less network energy saving (NES) cell.
